(19) United States
(12) Patent Application Publication
(10) Pub. No.: US 2024/0259841 A1
(43) Pub. Date: Aug. 1, 2024

(54) METHOD AND APPARATUS FOR CONTROLLING SIGNAL TRANSMISSION AND SYSTEM

(71) Applicant: FUJITSU LIMITED, Kawasaki-shi Kanagawa (JP)

(72) Inventors: Meiyi JIA, Beijing (CN); Lei ZHANG, Beijing (CN); Su YI, Beijing (CN)

(73) Assignee: FUJITSU LIMITED, Kawasaki-shi Kanagawa (JP)

(21) Appl. No.: 18/636,632

(22) Filed: Apr. 16, 2024

Related U.S. Application Data
(63) Continuation of application No. PCT/CN2021/124518, filed on Oct. 18, 2021.

(51) Int. Cl. H04W 24/02; H04B 7/06; H04L 1/1812; H04L 5/00; H04W 72/1268; H04W 72/231

(52) U.S. Cl. CPC H04W 24/02; H04B 7/0626; H04L 1/1812; H04L 5/0051; H04W 72/1268; H04W 72/231

(57) ABSTRACT

A method and apparatus for controlling signal transmission and a system. The method includes: first node starts or closes a first unit configured to transmit a first signal to a network device or a terminal equipment based on information received from the network device and/or detection of a signal from the network device or the terminal equipment.

### CROSS-REFERENCE TO RELATED APPLICATION

This application is a continuation of International Application No. PCT/CN2021/124518, filed on Oct. 18, 2021, the entire contents of which are incorporated herein by reference.

### FIELD

This disclosure relates to the field of communications.

### BACKGROUND

In an NR (New Radio) system, terminals face new challenges in energy saving due to flexible parameter sets, larger bandwidths, lower latency and more terminal antennas. In Release 16 (Rel-16), a terminal supports the following energy-saving technologies:
lowering PDCCH (physical downlink control channel) monitoring: including DRX (discontinuous reception) adaptation, i.e. DRX parameter configuration adjustment, PDCCH monitoring skip, and sleep signals;
time-domain adaptive energy-saving: i.e. cross-slot scheduling energy-saving technology, which allows a terminal to know in advance whether this time of scheduling is cross-slot scheduling or current slot scheduling; if it is cross-slot scheduling, the terminal may avoid unnecessary PDSCH (physical downlink shared channel) sampling and caching after receiving PDCCH symbols, and further, due to that processing time of cross-slot scheduling is relatively loose, the terminal may lower a processing capacity of a PDCCH;
frequency-domain adaptive energy-saving: including terminal adaptive switching BWP (bandwidth part) and secondary cell dormancy technology;
antenna domain adaptive energy-saving: configuring a maximum number of MIMO (multiple-input multiple-output) layers for each BWP by using RRC (radio resource control) signaling, and achieving switching of the maximum number of MIMO layers via BWP switching;
RRM (radio resource management) measurement relaxation; and
collaboration of terminal and network: reporting information such as release preferences, and expected DRX parameter configuration, etc., by the terminal to the network.

Currently, an energy-saving mode of a terminal in an idle and/or inactive state includes, for example, paging enhancement, so as to reduce unnecessary terminal paging reception, and provide TRS (tracking reference signal) and/or CSI-RS (channel state information reference signal) occasions available for connection state for terminals in an idle and/or inactive state, etc.; and an energy-saving mode of a terminal in a connected state includes PDCCH monitoring reduction, and measurement relaxing of RLF (radio link failure) and/or BFD (beam failure detection), etc.

In addition, in existing and future communication systems, network energy saving has also become an important subject. For network energy saving, possible technologies include: power amplifier voltage regulation, symbol shutdown, channel shutdown, cell shutdown, and deep sleep, etc.

It should be noted that the above description of the background is merely provided for clear and complete explanation of this disclosure and for easy understanding by those skilled in the art. And it should not be understood that the above technical solution is known to those skilled in the art as it is described in the background of this disclosure.

### SUMMARY

It was found by the inventors that for a current scenario where one or more additional nodes or devices or entities are supported, following problems exist:
1) the additional nodes or devices or entities, such as repeaters or reconfigurable intelligent surfaces (RISs), always process/amplify and transmit received RF signals, and even if the received RF signals do not include signals desired by a mobile terminal or a base station, such as a noise and an interference signal, resulting in interference to the mobile terminal or base station;
2) the additional nodes or devices or entities increase total power consumption of the communication system.

In order to solve at least one of the above problems or other similar problems, embodiments of this disclosure provide a method and apparatus for controlling signal transmission and a system.

According to an aspect of the embodiments of this disclosure, there is provided an apparatus for controlling signal transmission, including:
a first unit configured to transmit a first signal to a network device or a terminal equipment; and
a second unit configured to start or close the first unit based on information received from the network device and/or detection of a signal from the network device or the terminal equipment.

According to another aspect of the embodiments of this disclosure, there is provided an apparatus for controlling signal transmission, configured in a network device, the apparatus including:
a controlling unit configured to transmit information to a first node so that the first node, based on information received from the network device and/or detection of a signal from the network device or a terminal equipment, starts or closes a first unit used to transmit a first signal to the network device or the terminal equipment,
wherein the information is first information, such that the first node starts or closes the first unit based on the information received from the network device; and/or the information is configuration information including a first reference signal of the network device and/or configuration information including a second reference signal of the terminal equipment, such that the first node starts or closes the first unit based on detection of the first reference signal from the network device and/or detection of the second reference signal from the terminal equipment.

One of advantages of the embodiments of this disclosure exists in that based on the information received from the network device (such as a base station) and/or detection result of symbols/signals, the additional node or device or entity (referred to as a first node) starts or close the unit (referred to as a first unit) used to (process a received RF signal and) transmit the RF signal to a mobile device (such as a mobile terminal), which may avoid processing/amplifying and transmitting noise and interference signals when no data are transmitted, thereby eliminating interference to mobile devices. Furthermore, according to the embodiments of this disclosure, energy consumption of the additional node or device or entity (referred to as the first node) may be lowered, thereby reducing energy consumption of the communication system.

With reference to the following description and drawings, the particular embodiments of this disclosure are disclosed in detail, and the principle of this disclosure and the manners of use are indicated. It should be understood that the scope of the embodiments of this disclosure is not limited thereto. The embodiments of this disclosure contain many alternations, modifications and equivalents within the spirits and scope of the terms of the appended claims.

Features that are described and/or illustrated with respect to one embodiment may be used in the same way or in a similar way in one or more other embodiments and/or in combination with or instead of the features of the other embodiments.

It should be emphasized that the term “comprises/comprising/includes/including” when used in this specification is taken to specify the presence of stated features, integers, steps or components but does not preclude the presence or addition of one or more other features, integers, steps, components or groups thereof.

### BRIEF DESCRIPTION OF THE DRAWINGS

Elements and features depicted in one drawing or embodiment of the disclosure may be combined with elements and features depicted in one or more additional drawings or embodiments. Moreover, in the drawings, like reference numerals designate corresponding parts throughout the several views and may be used to designate like or similar parts in more than one embodiment.

The drawings are included to provide further understanding of this disclosure, which constitute a part of the specification and illustrate the preferred embodiments of this disclosure, and are used for setting forth the principles of this disclosure together with the description. It is obvious that the accompanying drawings in the following description are some embodiments of this disclosure, and for those of ordinary skills in the art, other accompanying drawings may be obtained according to these accompanying drawings without making an inventive effort. In the drawings:

FIG. 1 is schematic diagram of a deployment scenario of a repeater/RIS;

FIG. 2 is a schematic diagram of a simplified repeater model;

FIG. 3 is a schematic diagram of a simplified repeater model in a time division duplex (TDD) mode;

FIG. 4 is a schematic diagram of an IAB architecture;

FIG. 5 is a schematic diagram of multi-TRP operations;

FIG. 6 is a schematic diagram of a VMR;

FIG. 7 is a schematic diagram of the method for controlling signal transmission in an embodiment of this disclosure;

FIG. 8 is a schematic diagram of a structure of a smart repeater;

FIG. 9 is a schematic diagram of an IAB scenario;

FIG. 10 is a schematic diagram of a TRP scenario;

FIG. 11 is a schematic diagram of the method for configuring parameters of an embodiment of this disclosure;

FIG. 12 is a schematic diagram of the apparatus for controlling signal transmission in an embodiment of this disclosure;

FIG. 13 is a schematic diagram of the apparatus for configuring parameters of an embodiment of this disclosure;

FIG. 14 is a schematic diagram of the communication system of an embodiment of this disclosure;

FIG. 15 is a schematic diagram of the node device of an embodiment of this disclosure; and

FIG. 16 is a schematic diagram of the network device of an embodiment of this disclosure.

### DETAILED DESCRIPTION

These and further aspects and features of this disclosure will be apparent with reference to the following description and attached drawings. In the description and drawings, particular embodiments of the disclosure have been disclosed in detail as being indicative of some of the ways in which the principles of the disclosure may be employed, but it is understood that the disclosure is not limited correspondingly in scope. Rather, the disclosure includes all changes, modifications and equivalents coming within the spirit and terms of the appended claims.

In the embodiments of this disclosure, terms “first”, and “second”, etc., are used to differentiate different elements with respect to names, and do not indicate spatial arrangement or temporal orders of these elements, and these elements should not be limited by these terms. Terms “and/or” include any one and all combinations of one or more relevantly listed terms. Terms “contain”, “include” and “have” refer to existence of stated features, elements, components, or assemblies, but do not exclude existence or addition of one or more other features, elements, components, or assemblies.

In the embodiments of this disclosure, single forms “a”, and “the”, etc., include plural forms, and should be understood as “a kind of” or “a type of” in a broad sense, but should not defined as a meaning of “one”; and the term “the” should be understood as including both a single form and a plural form, except specified otherwise. Furthermore, the term “according to” should be understood as “at least partially according to”, the term “based on” should be understood as “at least partially based on”, except specified otherwise.

In the embodiments of this disclosure, the term “communication network” or “wireless communication network” may refer to a network satisfying any one of the following communication standards: long term evolution (LTE), long term evolution-advanced (LTE-A), wideband code division multiple access (WCDMA), and high-speed packet access (HSPA), etc.

And communication between devices in a communication system may be performed according to communication protocols at any stage, which may, for example, include but not limited to the following communication protocols: 1G (generation), 2G, 2.5G, 2.75G, 3G, 4G, 4.5G, and 5G and new radio (NR) in the future, etc., and/or other communication protocols that are currently known or will be developed in the future.

In the embodiments of this disclosure, the term “network device”, for example, refers to a device in a communication system that accesses a user equipment to the communication network and provides services for the user equipment. The network device may include but not limited to the following devices: a base station (BS), an access point (AP), a transmission reception point (TRP), a broadcast transmitter, a mobile management entity (MME), a gateway, a server, a radio network controller (RNC), a base station controller (BSC), etc.

The base station may include but not limited to a node B (NodeB or NB), an evolved node B (eNodeB or eNB), and a 5G base station (gNB), etc. Furthermore, it may include a remote radio head (RRH), a remote radio unit (RRU), a relay, or a low-power node (such as a femto, and a pico, etc.). The term “base station” may include some or all of its functions, and each base station may provide communication coverage for a specific geographical area. And a term “cell” may refer to a base station and/or its coverage area, depending on a context of the term.

In the embodiments of this disclosure, the term “user equipment (UE)” refers to, for example, an equipment accessing to a communication network and receiving network services via a network device, and may also be referred to as “a terminal equipment (TE)”. The terminal equipment may be fixed or mobile, and may also be referred to as a mobile station (MS), a terminal, a user, a subscriber station (SS), an access terminal (AT), or a station, etc.

The terminal equipment may include but not limited to the following devices: a cellular phone, a personal digital assistant (PDA), a wireless modem, a wireless communication device, a hand-held device, a machine-type communication device, a lap-top, a cordless telephone, a smart cell phone, a smart watch, and a digital camera, etc.

For another example, in a scenario of the Internet of Things (IoT), etc., the terminal equipment may also be a machine or a device performing monitoring or measurement. For example, it may include but not limited to a machine-type communication (MTC) terminal, a vehicle mounted communication terminal, a device to device (D2D) terminal, and a machine to machine (M2M) terminal, etc.

In an existing communication system, in order to increase coverage, one or more additional nodes or devices or entities (recorded as nodes/devices/entities) are added between a base station (such as a gNB or a gNB CU (control unit)) and a mobile terminal, which have simplified protocol stack functions of processing (such as amplifying, routing, etc.) signals or symbols (recorded as signals/symbols) received from the base station/mobile terminal and transmitting them to the mobile terminal/base station. The additional nodes/devices/entities may be repeaters/RISs, IAB (integrated access and backhaul) nodes, VMRs (vehicle-mounted replays), and TRPs, etc.

Usually, an additional node/device/entity includes two units or modes (recorded as unit/mode), one of which is used to communicate with a base station, such as an MT (mobile terminal) in an IAB-node, and the other is used to communicate with a mobile terminal, such as a DU (distributed unit) in the IAB-node. The two units/modes may operate in a frequency division or time division or space division (recorded as frequency division/time division/space division) manner.

Scenarios of using one or more additional nodes/devices/entities between a base station and a mobile terminal are all implementation scenarios in this disclosure, which are illustrated below.

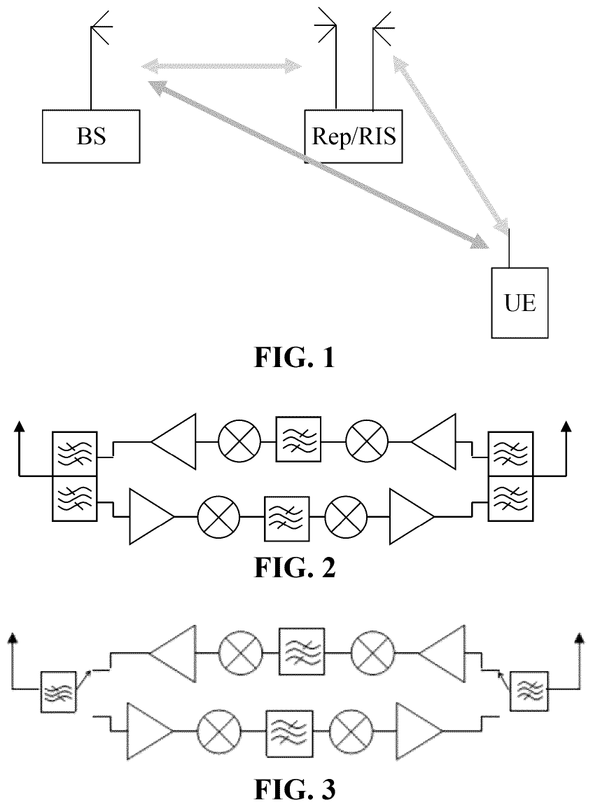

FIG. 1 is a schematic diagram of a deployment scenario of a repeater/RIS. As shown in FIG. 1, repeater/RIS is a device that receives, processes and transmits radiated or conducted RF carriers in a downlink direction (from a base station to a mobile area) and uplink direction (from a mobile terminal to a base station). For the repeater, its processing includes power amplification; and for the RIS, its processing includes beamforming, and reshaping a propagation environment, etc. In an operating frequency band that only specifies downlink or uplink, only the specified uplink or downlink is repeated.

FIG. 2 is a schematic diagram of a simplified repeater model. As shown in FIG. 2, the repeater is a bidirectional amplifier for RF signals in a downlink path from the base station and RF signals in an uplink path from a universal device taken as a mobile terminal. In Release 17 (Rel-17), a repeater that supports a TDD (time division duplex) mode is under consideration, and its model is as shown in FIG. 3.

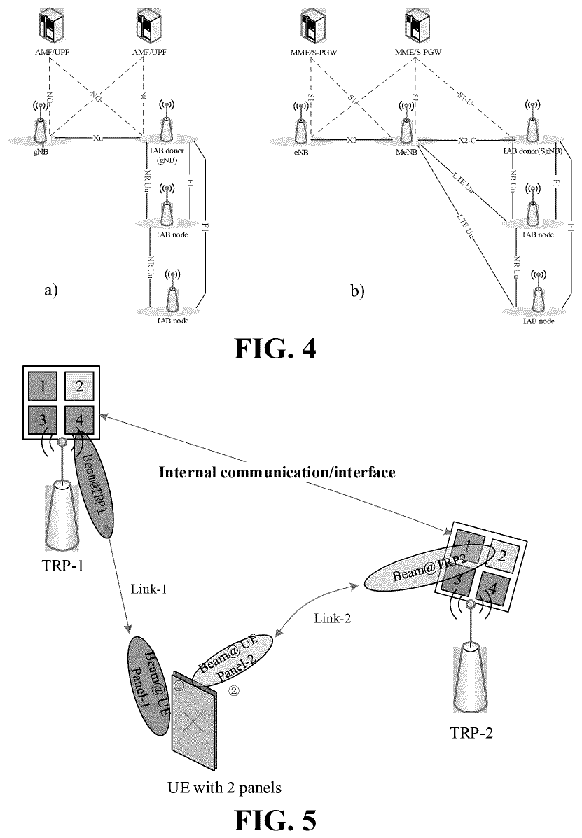

FIG. 4 is a schematic diagram of an IAB architecture. The IAB is used to ensure that radio signals in an NG-RAN (5G radio access network) may be relayed. A relay node, i.e., an IAB-node, supports NR access and backhauling. The backhauling may include a single hop or multiple hops. An endpoint of network side NR backhauling, namely an IAB-donor, represents a gNB that includes additional functions supporting IAB. An overall architecture of IAB is shown in FIG. 4, wherein a) uses an SA (standalone) mode, and b) uses an EN-DC (E-UTRA-NR dual connectivity) mode. In the EN-DC mode, an IAB-node is connected to an MeNB (master eNB) via E-UTRA (evolved UMTS (universal mobile telecommunications system) terrestrial radio access), and the IAB-node serves as an SgNB (secondary eNB) and terminates X2-C. In this example, the IAB-node supports functions of a gNB DU, i.e. an IAB-DU, which is terminated at an NR access interface of UEs and a next hop of IAB-nodes, and is terminated at an F1 protocol of a gNB-CU function on the IAB-donor. In addition, the IAB-node also supports a subset of UE functions, namely an IAB-MT, including, for example, functions of being connected to another IAB-node or a gNB DU of the IAB-donor, being connected to a gNB-CU on the IAB-donor, and being connected to a physical layer of a core network, L2 (Layer 2), RRC and NAS (non-access stratum).

FIG. 5 is a schematic diagram of multi-TRP operations. A TRP is a part of a gNB and is used to receive signals from a terminal UE or transmit signals to the terminal UE. As shown in FIG. 5, in the multi-TRP operations, a serving cell may schedule a UE from two TRPs, providing better PDSCH coverage, reliability and/or data rate. At present, TRP-1 and TRP-2 communicate via internal interfaces, and may use standardized interfaces in the future.

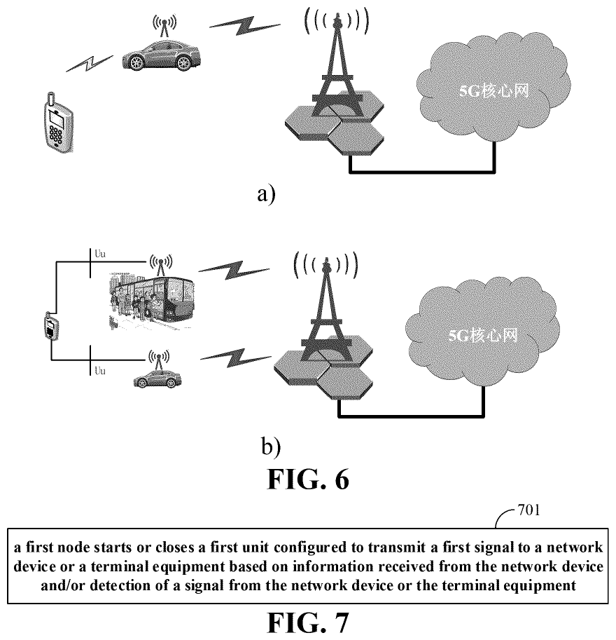

FIG. 6 is a schematic diagram of a VMR. The VMR is a mobile relay. As shown in FIG. 6, a mobile vehicle is equipped with a small on-board base station relay to provide 5G coverage and communicate with a mobile terminal (inside the vehicle and/or in the surrounding area), and is wirelessly connected to a 5G network via an RAN (radio access network) (donor) node. Main connection assumptions include: 1) 5G NR is used for a radio link between a mobile base station relay and a donor RAN node, and a radio link between the base station relay and the mobile terminal; 2) the mobile base station relay is connected to a 5G core network (5GC) via a donor RAN node; and 3) a single-hop relay is a primary/basic scenario.

Various implementations of the embodiments of this disclosure shall be described below with reference to the accompanying drawings. These implementations are illustrative only, and are not intended to limit this disclosure.

### Embodiment of a First Aspect

The embodiment of this disclosure provides a method for controlling signal transmission, which shall be described from a side of a first node. The first node is the above-described additional node/device/entity, such as the repeater or RIS in the scenario shown in FIG. 1, or the repeater in the scenario shown in FIG. 2 or FIG. 3, or the IAB-node in the scenario shown in FIG. 4, or the TRP in the scenario shown in FIG. 5, or the VMR in the scenario shown in FIG. 6. In the following description, for the sake of convenience, the node/device/entity in the above scenarios is referred to as a first node. However, this disclosure is not limited thereto, and the node/device/entity in the above scenarios may also be in other names.

FIG. 7 is a schematic diagram of the method for controlling signal transmission in the embodiment of this disclosure. Referring to FIG. 7, the method includes:

701: a first node starts or closes a first unit configured to transmit a first signal to a network device or a terminal equipment based on information received from the network device and/or detection of a signal from the network device or the terminal equipment.

In the above embodiment, the first node has a mode or unit (referred to as a first unit) used for transmitting a signal (referred to as a first signal) to a network device or a terminal equipment.

According to the embodiment of this disclosure, the first node starts or closes the first unit used for transmitting a signal to the network device or terminal equipment based on the information received from the network device and/or the detection result of a symbol/signal, which may avoid processing/amplifying and transmitting noise and interference signals when no data are transmitted, thereby eliminating interference to mobile devices. Furthermore, energy consumption of the first node may be lowered, thereby reducing energy consumption of the communication system.

In the above embodiment, the first unit is further used to receive an RF signal (referred to as a second signal) from terminal equipment or network device, and generate the first signal after processing the second signal.

In the above embodiment, the processing of the second signal by the first unit includes but is not limited to power amplification, beamforming, and reshaping propagation environment, etc. For example, if the first node is the above repeater, the first unit may perform power amplification on the received second signal to generate the above first signal; and if the first node is the above RIS, the first unit may perform beamforming, and reshaping propagation environment, etc., on the received second signal to generate the above first signal.

In some embodiments, the information received from the network device is RRC configuration information, and the first node starts or closes the first unit based on the RRC configuration information.

In one implementation, the above RRC configuration information may include information (referred to as first information) for indicating starting or closing the first unit, and the first node may start or close the first unit used for transmitting an RF signal (first signal) to the network device or the mobile terminal based on the first information.

In another implementation, transmission of the above RRC configuration information indicates starting or closing the first unit, that is, the RRC configuration information does not include information for indicating starting or closing the first unit, but indicates starting or closing the first unit via the transmission of the RRC configuration information. For example, taking that the transmission of the RRC configuration information indicates starting the first unit as an example, once the first node receives the RRC configuration information, it starts the first unit used for transmitting an RF signal (first signal) to the network device or terminal equipment by default.

In a further implementation, the transmission of the above RRC configuration information indicates starting or closing the first unit, and the RRC configuration information further includes the above first information. For example, the RRC configuration information is transmitted at different times. When the RRC configuration information is received at a certain time, the first unit is started by default, and when the RRC configuration information containing the first information is received at another time, the first unit is started or closed according to indication of the first information.

In the above embodiment, the RRC configuration information may include time-frequency information carrying the above first signal, such as beamforming information, timing information, and TDD configuration information, etc.

In the above embodiment, connectivity between the first node and the network device transmitting the RRC configuration information may be single connectivity, that is, dual connectivity is not configured. However, this disclosure is not limited thereto, the connectivity between the first node and the network device transmitting the RRC configuration information, as well as another network device (referred to as a second network device), may be dual connectivity, and the network device transmitting the RRC configuration information is a primary network device that provides services to the first node.

In some embodiments, the information received from the network device is a media access control control element (MAC CE), and the first node starts or closes the first unit based on the MAC CE.

In some embodiments, for example, the above MAC CE may be used to indicate starting or closing the first unit. That is, the MAC CE includes only information on starting or closing the first unit. This implementation is applicable to cases where the first node is configured with carrier aggregation or is not configured with carrier aggregation.

In some other implementations, for example, the above MAC CE may be used to indicate starting or closing a first unit corresponding to one or more carriers. For example, the MAC CE may include the above one or more carriers and corresponding information on starting or closing the first unit. These implementations are applicable to a case where the first node is configured with carrier aggregation.

In the above implementation, the MAC CE may be transmitted on a primary carrier or on a specific carrier (referred to as a first carrier), which may be a carrier in a licensed band, or a carrier with no shared spectrum channel operation configured, or a carrier carrying a control channel (such as a PDCCH or a PUCCH), or a carrier carrying a common channel (such as a PRACH or a PBCH), or a carrier serving as a downlink reference (such as a pathloss reference or a timing reference), etc., and this disclosure is not limited thereto.

In some embodiments, if the information received from the network device is DCI, the first node starts or closes the first unit based on the DCI.

In one implementation, the DCI is a common indication for more than one first nodes. For example, the DCI is CRC scrambled via a P-RNTI, which is used to indicate starting or closing the first unit, in addition to paging and notifying system information changes.

In the above implementation, the DCI uses DCI format 1_0, and one bit of the DCI is used to indicate starting or closing the first unit. For example, for information transmitted via DCI format 1-0 being CRC scrambled via P-RNTI on the PDCCH, the fourth bit (bit 4) in a short message may be used to carry the information indicating starting or closing the first unit. For example, if the bit is set to be 1, it indicates that the first unit is started. This bit is only valid for a device having the first unit (such as the above first node), and for other types of devices, such as mobile terminals, this bit may be ignored.

In the above implementation, the DCI may also schedule a PDSCH, which may carry information containing identifier(s) of one or more first nodes. For example, 1) “11” in an existing short message indicator is used to indicate that the scheduling information and short message are present in the DCI, and the identifier(s) of the one or more first nodes is/are carried in the PDSCH scheduled by the DCI. Thus, whether the one or more first units is/are started or closed is indicated via the scheduling information and short message.

In another implementation, the DCI is a dedicated indication for a first node. For example, the DCI is CRC (cyclic redundancy check) scrambled via a first RNTI (radio network temporary identifier), and uses a first DCI format, and one and/or more bits of the DCI is/are used to indicate starting or closing the first unit.

In one example, the first DCI format is DCI format 2_6, the first RNTI is a PS-RNTI, and one bit of the DCI is used to indicate starting or closing the first unit. In this example, if the DCI further includes SCell (secondary cell) dormancy indication information (0-5 bits), another bit of the DCI is used to indicate whether the SCell dormancy indication information is applicable to a corresponding first unit.

In another example, the first DCI format is DCI format 2_6, the first RNTI is a PS-RNTI, one bit of the DCI (referred to as a first bit) is used to indicate starting or closing the first unit, and another bit of the DCI (referred to as a second bit) is used to indicate wakeup. When the second bit is set to be a predetermined value, the first bit is valid; otherwise, the first bit is ignored.

In a further example, the first DCI format is DCI format 2_6, the first RNTI is a PS-RNTI, multiple bits of the DCI are used to indicate starting or closing the first unit. When one of the multiple bits is set to be a first predetermined value, such as 0, it indicates closing a corresponding first unit (which is operating now); and when one of the multiple bits is set to be a second predetermined value, such as 1, it indicates starting a corresponding first unit (which is closed before).

In this example, the bit number of the multiple bits of the DCI used to indicate starting or closing the first unit is related to the first node or an RF capability of the first unit of the first node. For the sake of convenience, the RF capability is referred to as an RF capability of the first node in the embodiment of this disclosure, and a highest bit in the multiple bits corresponds to a radio frequency with a lowest or highest center frequency point; wherein, the bit number may be configured by the network device. For example, the first node reports an RF capability of itself to the network device, and the network device configures the above bit number for the first node according to the RF capability of the first node.

Or, the bit number of the multiple bits of the DCI used to indicate starting or closing the first unit is the number of first unit on/off cell groups, a first unit on/off cell group is associated with one or more cells, and a highest bit in the multiple bits corresponds to a configured first one of the first unit on/off cell groups. In this example, the cell may be a serving cell, or a neighboring cell, or a cell configured by a device, or a special cell, or an active secondary cell, or any combination of the above cells, or other cells, and this disclosure is not limited thereto. In addition, the cells associated with the above first unit on/off cell groups may be configured by the network device, and a configuration method is not limited in this disclosure.

In still another example, the first DCI format is a new DCI format, the first RNTI is a new RNTI, and one or more bits of the DCI is/are used to indicate starting or closing the first unit. For example, a new DCI format being CRC scrambled via the new RNTI is used to notify the information on starting or closing the first unit to one or more devices out of a DRX activation time.

In this example, in a case of indicating starting or closing the first unit via one bit of the DCI, if there exists an SCell dormancy indication (0-5 bits), another bit of DCI may be used to indicate whether the SCell dormancy indication is applicable to a corresponding first unit.

In this example, in a case of indicating starting or closing the first unit via one bit of the DCI, if a wakeup indication bit is set to be 1, it may be determined that the above one bit is valid; otherwise, the indication of the above one bit may be ignored.

In this example, in a case of indicating starting or closing the first unit via multiple bits of the DCI, when one of the above multiple bits is set to be the first predetermined value, such as 0, it indicates closing a corresponding first unit (which is operating now); and when one of the above multiple bits is set to be the second predetermined value, such as 1, it indicates starting a corresponding first unit (which is closed before).

In this example, the bit number of the multiple bits may be related to the RF capability of the first node, and the highest bit in the multiple bits may correspond to the radio frequency with a lowest or highest center frequency point; wherein, the bit number may be configured by the network device. For example, the first node reports the RF capability of itself to the network device, and the network device configures the above bit number for the first node according to the RF capability of the first node. Or, the bit number of the multiple bits is the number of first unit on/off cell groups, a first unit on/off cell group is associated with one or more cells, and a highest bit in the multiple bits corresponds to a configured first one of the first unit on/off cell groups. In this example, the cell may be a serving cell, or a neighboring cell, or a cell configured by a device, or a special cell, or an active secondary cell, or any combination of the above cells, or other cells, and this disclosure is not limited thereto. In addition, the cells associated with the above first unit on/off cell groups may be configured by the network device, and a configuration method is not limited in this disclosure.

In this example, the above new RNTI is used to indicate starting or closing the first unit, and its value may be one of currently reserved values FFF3˜FFFD, such as FFF3, or FFFD; and it may also share 0001-FFFF2 with other RNTIs, and this disclosure is not limited thereto. In addition, the new RNTI may be used to scramble signals transmitted via the PDCCH, and the scrambled transmitted signals are not mapped to MAC, are only used for a physical layer, and are not applicable to restrictions on transmitted signals/logical channels.

In yet another example, the first DCI format is DCI format 1_0 or DCI format 1_1, the first RNTI is a new RNTI, and one or more bits of the DCI is/are used to indicate starting or closing the first unit. That is, DCI format 1_0 or DCI format 1_1 being CRC scrambled via the new RNTI is used to notify the information on starting or closing the first unit to one or more devices (out of a DRX activation time).

In this example, in a case of indicating starting or closing the first unit via one bit of the DCI, if there exists an SCell dormancy indication (0-5 bits), whether the SCell dormancy indication is applicable to a corresponding first unit may be indicated via another bit of the DCI.

In this example, in a case of indicating starting or closing the first unit via one bit of the DCI, if the wakeup indication bit is set to be 1, it may be determined that the one bit is valid; otherwise, the indication of the one bit may be ignored.

In this example, in a case of indicating starting or closing the first unit via multiple bits of the DCI, when one of the multiple bits is set to be the first predetermined value, such as 0, it indicates closing a corresponding first unit (which is operating now); and when one of the above multiple bits is set to be the second predetermined value, such as 1, it indicates starting of a corresponding first unit (which is closed before).

In this example, the bit number of the multiple bits is related to the RF capability of the first node, and the highest bit in the multiple bits may correspond to the radio frequency with a lowest or highest center frequency point; wherein, the bit number may be configured by the network device. For example, the first node reports the RF capability of itself to the network device, and the network device configures the above bit number for the first node according to the RF capability of the first node. Or, the bit number of the multiple bits is the number of first unit on/off cell groups, a first unit on/off cell group is associated with one or more cells, and a highest bit in the multiple bits corresponds to a configured first one of the first unit on/off cell groups. In this example, the cell may be a serving cell, or a neighboring cell, or a cell configured by a device, or a special cell, or an active secondary cell, or any combination of the above cells, or other cells, and this disclosure is not limited thereto. In addition, the cells associated with the above first unit on/off cell groups may be configured by the network device, and a configuration method is not limited in this disclosure.

In this example, the above new RNTI is used to indicate starting or closing the first unit, and its value may be one of currently reserved values FFF3˜FFFD, such as FFF3, or FFFD; and it may also share 0001-FFFF2 with other RNTIs, and this disclosure is not limited thereto. In addition, the new RNTI may be used to scramble signals transmitted via the PDCCH, and the scrambled transmitted signals are not mapped to MAC, are only used for a physical layer, and are not applicable to restrictions on transmitted signals/logical channels.

In this example, if one bit or one of the multiple bits of the DCI is used to indicate closing the first unit, resource allocation bits of the DCI may be reserved; otherwise, the first DCI format indicates time-frequency resources of the scheduled PDSCH.

In still another example, the first DCI format is DCI format 1_0 or DCI format 1_1, the first RNTI is a C-RNTI, and one or more bits of the DCI is/are used to indicate starting or closing the first unit. That is, DCI format 1_0 or DCI format 1_1 being CRC scrambled via the C-RNTI is used to notify the information on starting or closing the first unit to one or more devices (out of a DRX activation time).

In this example, in a case of indicating starting or closing the first unit via one bit of the DCI, if there exists an SCell dormancy indication (0-5 bits), whether the SCell dormancy indication is applicable to a corresponding first unit may be indicated by another bit of the DCI.

In this example, in a case of indicating starting or closing the first unit via one bit of the DCI, if the wakeup indication bit is set to be 1, it may be determined that the one bit is valid; otherwise, the indication of the one bit may be ignored.

In this example, in a case of indicating starting or closing the first unit via multiple bits of the DCI, when one of the multiple bits is set to be the first predetermined value, such as 0, it indicates closing a corresponding first unit (which is operating now); and when one of the multiple bits is set to be the second predetermined value, such as 1, it indicates starting a corresponding first unit (which is closed before).

In this example, the bit number of the multiple bits is related to the RF capability of the first node, and the highest bit in the multiple bits may correspond to the radio frequency with a lowest or highest center frequency point; wherein, the bit number may be configured by the network device. For example, the first node reports the RF capability of itself to the network device, and the network device configures the above bit number for the first node according to the RF capability of the first node. Or, the bit number of the multiple bits is the number of first unit on/off cell groups, a first unit on/off cell groups is associated with one or more cells, and a highest bit in the multiple bits corresponds to a configured first one of the first unit on/off cell groups. In this example, the cell may be a serving cell, or a neighboring cell, or a cell configured by a device, or a special cell, or an active secondary cell, or any combination of the above cells, or other cells, and this disclosure is not limited thereto. In addition, the cells associated with the above first unit on/off cell groups may be configured by the network device, and a configuration method is not limited in this disclosure.

The above embodiments only illustrate the information received from the network device by taking that the information received from the network device is the RRC configuration information, MAC CE and DCI as an example. However, this disclosure is not limited thereto, and appropriate variants may be made on the basis of these implementations. For example, the above implementations may be executed separately, or one or more of them may be executed in a combined manner.

In the embodiment of this disclosure, in order to enable the first node to receive the information from the network device, the network device and/or the first node may further perform corresponding configuration or processing.

In some embodiments, the network device and/or the first node may make the first node to involuntarily enter an idle state and/or maintain a connected state, so that the first node may receive information from the network device.

For example, the network device does not configure dataInactivity Timer for the first node. For example, the network device may change conditions on configuration, that is, the configuration information transmitted by the network device to the first node (referred to as first configuration information) does not include dataInactivityTimer configuration for the first node; or, the network device may perform no processing (i.e. there exists no influence on protocols), that is, the first configuration information transmitted by the network device to the first node includes dataInactivityTimer configuration for the first node, but the first node ignores or does not apply the dataInactivityTimer configuration included in the first configuration information transmitted by the network device.

In the above example, for the first node, the first node is able to receive the first configuration information from the network device, but the first configuration information does not include the dataInactivityTimer configuration for the first node, or the first configuration information includes the dataInactivity Timer configuration for the first node, but the first node ignores or does not apply the dataInactivity Timer configuration included in the first configuration information.

For another example, the network device may configure for the first node that dataInactivityTimer is an infinite value, that is, the network device transmits the first configuration information to the first node, and the first configuration information includes the dataInactivityTimer configuration for the first node, but the value of dataInactivityTimer is an infinite value.

In the above example, for the first node, it may receive the first configuration information from the network device, the first configuration information includes the dataInactivityTimer configuration, and the value of dataInactivityTimer is configured to be infinite.

For another example, the first node may not perform data inactivity monitoring. For example, an MAC entity of the first node does not start or restart dataInactivityTimer when it receives an MAC SDU or transmits an MAC SDU.

For a further example, the MAC entity of the first node may not indicate expiration of dataInactivityTimer to an upper layer.

For still another example, the RRC layer of the first node may not perform a behavior of entering an RRC idle state (RRC-IDLE) when it receives expiration of dataInactivity Timer from a lower layer.

In some other embodiments, if the first node is configured with carrier aggregation, the network device and/or the first node may make the secondary cell where the first node is located not to deactivate autonomously, so that the first node is able to receive the information from the network device.

For example, the network device does not configure sCellDeactivation Timer for the first node. For example, the network device may change conditions on configuration, that is, the configuration information transmitted by the network device to the first node (referred to as second configuration information) does not include sCellDeactivationTimer configuration for the first node; or, the network device may not perform any processing (i.e. there exists no influence on protocols), that is, the second configuration information transmitted by the network device to the first node includes sCellDeactivation Timer configuration for the first node, but the first node ignores or does not apply the sCellDeactivationTimer configuration included in the second configuration information transmitted by the network device.

In the above example, for the first node, the first node is able to receive the second configuration information from the network device, but the second configuration information does not include the sCellDeactivationTimer configuration for the first node, or the second configuration information includes the sCellDeactivationTimer configuration for the first node, but the first node ignores or does not apply the sCellDeactivationTimer configuration included in the second configuration information.

For another example, the network device may configure for the first node that sCellDeactivationTimer is an infinite value, that is, the network device transmits the second configuration information to the first node, and the second configuration information includes the sCellDeactivation Timer configuration for the first node, but the value of sCellDeactivation Timer is an infinite value.

In the above example, for the first node, it may receive the second configuration information from the network device, the second configuration information includes the sCellDeactivationTimer configuration, and the value of sCellDeactivationTimer is configured to be infinite.

In some other embodiments, if the first node is configured with a BWP, the network device and/or the first node may not use a dormant BWP, or may not support autonomous switching to a default BWP, so that the first node may receive the information from the network device.

For example, the network device does not configure DormantBWP-Config for the first node. For example, the network device may change conditions on configuration, that is, the configuration information transmitted by the network device to the first node (referred to as third configuration information) does not include DormantBWP-Config configuration for the first node; or, the network device may not perform any processing (i.e. there exists no influence on protocols), that is, the third configuration information transmitted by the network device to the first node includes DormantBWP-Config configuration for the first node, but the first node ignores or does not apply the DormantBWP-Config configuration included in the third configuration information transmitted by the network device.

In the above example, for the first node, the first node is able to receive the third configuration information from the network device, but the third configuration information does not include the DormantBWP-Config configuration for the first node, or the third configuration information includes the DormantBWP-Config configuration for the first node, but the first node ignores or does not apply the sCellDeactivationTimer configuration included in the third configuration information.

For another example, when the first node receives a PDCCH indicating entering into the dormant BWP, it does not perform BWP switching, that is, the first node maintains a current active BWP and does not activate the dormant BWP, or, the first node performs switching from a BWP to the default BWP.

For another example, the network device does not configure bwp-InactivityTimer for the first node. For example, the network device may change conditions on configuration, that is, the configuration information transmitted by the network device to the first node (referred to as fourth configuration information) does not include bwp-Inactivity Timer configuration for the first node; or, the network device may not perform any processing (i.e. there exists no influence on protocols), that is, the fourth configuration information transmitted by the network device to the first node includes the bwp-Inactivity Timer configuration for the first node, but the first node ignores or does not apply the bwp-Inactivity Timer configuration included in the fourth configuration information transmitted by the network device.

In the above example, for the first node, the first node is able to receive the fourth configuration information from the network device, but the fourth configuration information does not include the bwp-Inactivity Timer configuration for the first node, or the fourth configuration information includes the bwp-InactivityTimer configuration for the first node, but the first node ignores or does not apply the bwp-InactivityTimer configuration included in the fourth configuration information.

For another example, the network device may configure for the first node that bwp-Inactivity Timer is an infinite value, that is, the network device transmits the fourth configuration information to the first node, and the fourth configuration information includes the bwp-Inactivity Timer configuration for the first node, but a value of bwp-InactivityTimer is infinite.

In the above example, for the first node, the first node is able to receive the fourth configuration information from the network device, and the fourth configuration information includes the bwp-Inactivity Timer configuration, and a value of bwp-InactivityTimer is configured to be infinite.

For another example, the first node does not start or restart bwp-Inactivity Timer.

For a further example, if bwp-Inactivity Timer associated with an active DL BWP expires, the first node does not perform BWP switching, or maintains a current active BWP, and does not activate a default or initial DL BWP.

The above embodiments only illustrate how to make the first node to receive the information from the network device. However, this disclosure is not limited thereto, and appropriate variants may be made on the basis of these implementations. For example, the above implementations may be executed separately, or one or more of them may be executed in a combined manner.

In the embodiment of this disclosure, regarding DRX configuration, the network device and/or the first node may also perform corresponding configuration or processing.

In some embodiments, the first node does not perform DRX. That is, the network device does not configure DRX for the first node.

In some other embodiments, the network device may configure a DRX for the first node, the DRX is configured for a terminal equipment that may possibly be served by the first node, and the terminal equipment that may possibly be served may be in an idle/inactive state, or a connected state. For example, the network device may transmit configuration information (referred to as fifth configuration information) to the first node, the fifth configuration information includes a DRX configuration, the DRX configuration is used for the terminal equipment in an idle and/or an inactive state and/or a connected state that may possibly be served by the first node. For the first node, it is able to receive the above fifth configuration information.

In the above embodiment, the DRX configuration includes: a DRX cycle, an on-duration value, an inactivity-timer value, and a retransmission-timer value.

In one embodiment, the above DRX configuration includes a first DRX cycle or a second DRX cycle, or a smaller one in the first DRX cycle and the second DRX cycle. The first DRX cycle is a minimum cycle of the terminal equipment in an idle and/or inactive state, and the second DRX cycle is a minimum cycle of the terminal equipment in a connected state. That is, the DRX cycle of the DRX configuration is the minimum cycle of the terminal equipment in an idle and/or inactive state, or the minimum cycle of the terminal equipment in a connected state, or a smaller one in the minimum cycle of the terminal equipment in an idle and/or inactive state and the minimum cycle of the terminal equipment in a connected state.

In one embodiment, the above DRX configuration includes a first on-duration value or a second on-duration value, or a larger one in the first on-duration value and the second on-duration value. The first on-duration value is a maximum on-duration value of the terminal equipment in an idle and/or inactive state, or a maximum on-duration value in a DRX cycle of the terminal equipment in an idle and/or inactive state, and the second on-duration value is a maximum on-duration value of the terminal equipment in a connected state, or a maximum on-duration value in a DRX cycle of the terminal equipment in a connected state. That is, the on-duration value of the DRX configuration is a maximum on-duration value of the terminal equipment in an idle and/or inactive state, or a maximum on-duration value in a DRX cycle of the terminal equipment in an idle and/or inactive state, or a maximum on-duration value of the terminal equipment in a connected state, or a maximum on-duration value in a DRX cycle of the terminal equipment in a connected state.

In one embodiment, the above DRX configuration includes a first inactivity-timer value, and the first inactivity-timer value is a minimum inactivity-timer value of the terminal equipment in a connected state. That is, the inactive-timer value of the DRX configuration is a minimum inactivity-timer value of the terminal equipment in a connected state.

In one embodiment, the above DRX configuration includes a first retransmission-timer value, and the first retransmission-timer value is a maximum retransmission-timer value of the terminal equipment in a connected state. That is, the retransmission-timer value of the DRX configuration is a maximum retransmission-timer value of the terminal equipment in a connected state.

In some other embodiments, the network device may configure at least two DRXes for the first node, namely, a group of DRX parameters, the DRX parameters including a DRX cycle, an on-duration value, an inactivity-timer value, and a retransmission-timer value, etc. The two DRX configurations are used for terminal equipment that may possibly be served by the first node, and the terminal equipment that may possibly be served may be in an idle/inactive state, or may be in a connected state. For example, the network device may transmit configuration information (referred to as sixth configuration information) to the first node, the sixth configuration information including at least two DRX configurations. And for the first node, it is able to receive the sixth configuration information.

In one embodiment, the above at least two DRX configurations are used for terminal equipment that may possibly be served by the first node, and each of the terminal equipments that may possibly be served corresponds to a DRX configuration. That is, the network device configures a DRX for each of the terminal equipments that may possibly be served.

In another embodiment, the above at least two DRX configurations are two DRX configurations, one of which is used for terminal equipment in an idle or inactive state that may possibly be served by the first node, and the other is used for terminal equipment in a connected state that may possibly be served by the first node. That is, the network device configures two DRXes for the terminal equipment, one of which is configured for the terminal equipment in the idle or inactive state that may possibly be served, and the other is configured for the terminal equipment in the connected state that may possibly be served.

In a further embodiment, the above at least two DRX configurations are two DRX configurations, one of which has a short DRX cycle, and the other has a long DRX cycle. That is, the network device configures the terminal equipment with two DRXes, one of which has a short DRX cycle, and the other has a long DRX cycle.

In still another embodiment, the above at least two DRX configurations are two DRX configurations, one of which has a large on-duration value, and the other has a small on-duration value. That is, the network device configures the terminal equipment with two DRXes, one of which has a large on-duration value, and the other has a small on-duration value.

The above embodiments only illustrate the DRX configurations of the first node. However, this disclosure is not limited thereto, and appropriate variants may be made on the basis of these implementations. For example, the above implementations may be executed separately, or one or more of them may be executed in a combined manner.

For example, based on the configuration of the network device, the first node does not perform DRX, or the first node performs the above processing based on the one DRX or at least two DRXes configured by the network device. That is, if the network device does not configure a DRX, the first node does not perform DRX, and if the network device configures the above one DRX or at least two DRXes, the first node performs the above processing according to the configured DRX parameters.

For another example, based on L2 or L1 indication of the network device, the first node does not perform DRX, or performs the above processing according to the above one DRX or at least two DRXes configured by the network device. That is, the network device provides the above multiple groups of DRX parameter configurations via RRC signaling, and optionally indicates which mode is adopted for processing; and when needed (for example, services of the terminal equipment change, and the terminal equipment possibly served by the first node changes), the network device may indicate which mode is adopted for corresponding processing to the first node via MAC signaling or L1.

In the embodiment of this disclosure, starting or closing the first unit by the first node based on the detection of signals from the network device or the terminal equipment may be that the first node obtains measurement results based on measurement of the signals from the network device or the terminal equipment, and if the measurement results satisfy predetermined conditions, such as being greater than or less than a threshold, it starts or closes the first unit.

In the above embodiment, the above threshold may be provided by OAM, or may be configured by the network device, and this disclosure is not limited thereto. In addition, starting or closing the first unit by the first node based on the detection of signals from the network device or the terminal equipment may be configured by OAM, or may be configured by the network device. Furthermore, a measurement quantity, the conditions needing to be satisfied and subsequent processing may all be configured by OAM or by the network device.

In the above embodiment, the measurement based on the signals from the network device may be SINR measurement based on the signals, or may be RSRP/RSRQ measurement based on the signals, or may be RSSI measurement based on the signals. For example, the SINR may be an SS-SINR or a CSI-SINR, or an L1/L3-SINR. In addition, the RSRP/RSRQ may be SS-RSRP/RSRQ, or may be CSI-RSRP/RSRQ, or may be L1/L3-RSRP/RSRQ. In addition, the RSSI may be a CLI-RSSI.

In the above embodiment, the measurement based on the signals from the terminal equipment may be SINR measurement based on the signals, or may be RSRP/RSRQ measurement based on the signals, or may be RSSI measurement based on the signals. In this example, SINR may be an SRS-SINR, which is defined as linear evaluation (in units of W) of power contribution of resource elements bearing/carrying SRS reference signals divided by linear evaluation of power distribution of noise and interference. In addition, the RSRP/RSRQ may be an SRS-RSRP/RSRQ, or may be L1/L3-RSRP. In addition, the RSSI may be a CLI-RSSI.

For example, the first node performs measurement on configured SSs or CSI-RSs from the network device. If an SS-SINR or CSI-SINR of its L1 is less than a first threshold provided by the network or configured by OAM, the first unit is closed (started), and if the SS-SINR or CSI-SINR of its L1 is greater than a second threshold provided by the network or configured by OAM, the first unit is started (closed). Values of the first or second threshold corresponding to the SSs or CSI-RSs may be identical or different.

For another example, the first node performs measurement on configured SSs or CSI-RSs from the terminal equipment. If an SS-SINR or CSI-SINR of its L1 is less than a third threshold provided by the network or configured by OAM, the first unit is closed (started), and if the SS-SINR or CSI-SINR of its L1 is greater than a fourth threshold provided by the network or configured by OAM, the first unit is started (closed). Values of the third or fourth threshold corresponding to the SSs or CSI-RSs may be identical or different.

For a further example, the first node performs measurement on configured SSs or CSI-RSs from the network device and performs measurement on SRSs from the terminal equipment. If an SS-SINR or CSI-SINR of its L1 is less than a fifth A threshold provided by the network or configured by OAM and an SRS-SINR of its L1 is less than a fifth B threshold provided by the network or configured by OAM, the first unit is closed (started), and if the SS-SINR or CSI-SINR of its L1 is greater than a sixth A threshold provided by the network or configured by OAM and the SRS-SINR of its L1 is greater than a sixth B threshold provided by the network or configured by OAM, the first unit is started (closed). Values of the fifth or sixth threshold corresponding to the SSs or CSI-RSs or SRSs may be identical or different.

In the above embodiment, after obtaining the measurement results, the first node may further process the measurement results and compare the processed measurement results with the above predetermined conditions.

In an example, the above processing includes hysteresis processing or specific offset processing. The hysteresis processing is, for example, processing of subtracting or adding hysteresis parameters to the measurement results, and the specific offset processing is, for example, processing of adding specific offsets to the measurement results. In this example, the specific offsets may be frequency-specific, or cell-specific, or measurement-object-specific, or measurement-quantity-specific, or time-specific offsets, and this disclosure is not limited thereto.

In an example, that the measurement results satisfy the predetermined conditions may refer to that one or more measurement results of one or more measurement quantities in the measurement results satisfy or simultaneously satisfy the predetermined conditions, or, it may refer to that the measurement results satisfy the predetermined conditions within a certain period of time.

In the embodiment of this disclosure, that the first node closes the first unit may be that the first node performs one of the following behaviors or a combination thereof:
closing a power amplifier;
reducing channels;
closing a radio frequency chain (RF chain) used for transmitting and receiving with the terminal equipment;
closing an associated timer;
clearing associated configured downlink assignment and a configured uplink grant type 2;
clearing associated physical uplink shared channel (PUSCH) resources of semi-persistent channel state information (CSI) reporting;
suspending or clearing associated configured uplink grant type 1;
flushing all associated hybrid automatic repeat request (HARQ) buffers;
releasing a PDCCH (if configured);
releasing a downlink reference signal (DL RS) (if configured), including SS/CSI-RS, etc.;
stopping or relaxing measurement for an uplink reference signal (such as an SRS); and
initializing parameter configuration.

In an example, the closing the power amplifier may be closing at a symbol level, so as to eliminate interference; the reducing channels may be closing some channels within an AAU (active antenna unit), so as to achieve a goal of power saving; and the closing a radio frequency chain used for transmitting and receiving with the terminal equipment includes closing at least one of a baseband processing module, a digital intermediate frequency module, a small signal processing module and a power amplifier module, and may also include closing a power supply module, etc.

In an example, the relaxing measurement includes extending an RRM measurement cycle, and reducing the number of measurement samples within the RRM measurement cycle, etc.

In the embodiment of this disclosure, that the first node starts the first unit may be that the first node performs one of the following behaviors or a combination thereof:
starting a power amplifier;
increasing channels;
starting a radio frequency chain (RF chain) used for transmitting and receiving with the terminal equipment;
stopping an associated timer;
initializing (re-initializing) and starting a suspended configured uplink grant type 1 according to stored configuration; and
starting measurement for an uplink reference signal (such as an SRS).

In an example, the closing the power amplifier may be closing at a symbol level; the increasing channels may be starting some channels within an AAU; and starting a radio frequency chain used for transmitting and receiving with the terminal equipment includes starting at least one of a power supply module, a baseband processing module, a digital intermediate frequency module, a small signal processing module and a power amplifier module.

In the above embodiment, reference may be made to relevant techniques for contents of the AAU, such as 5G AAU, which is omitted herein.

The method of the embodiment of this disclosure shall be described below with reference to implementation scenarios.

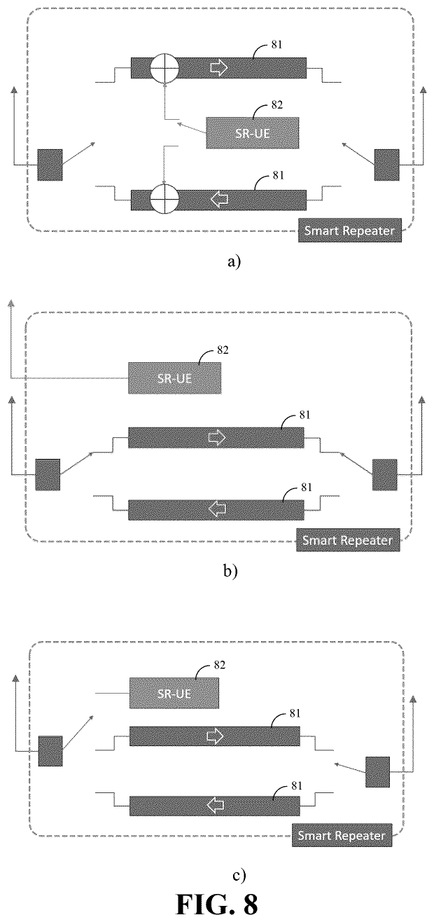

FIG. 8 is a schematic diagram of a structure of a smart repeater (SR), showing three different structures of the SR. As shown in FIG. 8, the SR is the first node of the embodiment of this disclosure, wherein the repeater 81 executes the function of the first unit in the above embodiment, and a function of SR-UE 82 is similar to that of the terminal equipment, which is omitted herein.

According to the method of the embodiment of this disclosure, based on the information received from the network device and/or the detection results of symbols/signals, the SR starts or closes the repeater used to (process the received RF signal and) transmit the RF signal to a mobile terminal, which may avoid processing/amplifying and transmitting noise and interference signals when no data are transmitted, thereby eliminating interference to the terminal equipment. Furthermore, energy consumption of the SR or RIS may be lowered, thereby reducing energy consumption of the communication system.

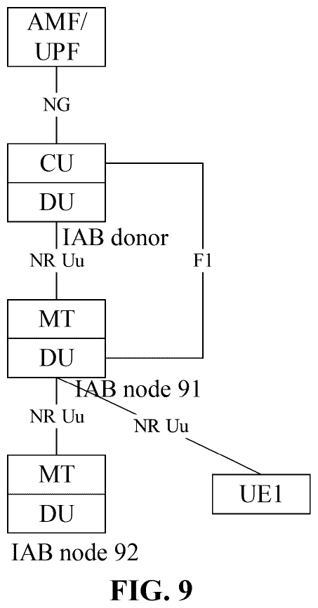

FIG. 9 is a schematic diagram of an IAB scenario, showing connection cases of the IAB-node. As shown in FIG. 9, IAB-node 91 and IAB-node 92 are the first nodes of the embodiment of this disclosure. For UE1 as the terminal equipment, IAB-node 91 is the first node of the embodiment of this disclosure, and an IAB-donor is the network device. In this example, one IAB-node includes two units, namely an MT and a DU. A function of the MT is similar to that of the terminal equipment, and the DU executes the function of the first unit in the above embodiment.

According to the method of the embodiment of this disclosure, based on the information received from the network device and/or the detection results of symbols/signals, the IAB-node starts or closes the DU used to (process the received RF signal and) transmit the RF signal to the mobile terminal, which may lower energy consumption of the IAB-node, thereby reducing energy consumption of the communication system.

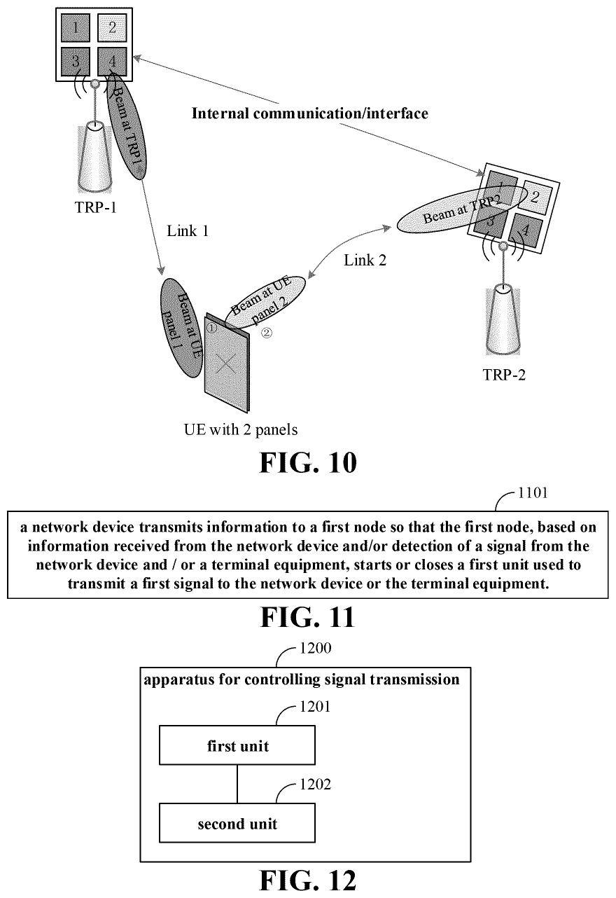

FIG. 10 is a schematic diagram of a TRP scenario. As shown in FIG. 10, a gNB where TRP-2 is located is the first node of the embodiment of this disclosure, and a gNB where TRP-1 is located is the network device. TRP-2 and TRP-1 may belong to different gNBs, and may exchange information via an X2 interface; or, TRP-2 and TRP-1 may be a part of a gNB, may belong to the same gNB, and exchange information by using an internal interface. In this example, TRP-2 executes the function of the first unit in the above embodiment.

According to the method of the embodiment of this disclosure, based on the information received from the network device and/or the detection results of symbols/signals, the TRP used to transmit the RF signal to the mobile terminal is started or closed, which may lower energy consumption of the equipment, thereby reducing energy consumption of the communication system.

The steps or processes related to this disclosure are only described above; however, this disclosure is not limited thereto. The method of the embodiment of this disclosure may also include other steps or processes, and reference may be made to relevant techniques for specific contents of these steps or processes.

The above implementations only illustrate the embodiment of this disclosure. However, this disclosure is not limited thereto, and appropriate variants may be made on the basis of these implementations. For example, the above implementations may be executed separately, or one or more of them may be executed in a combined manner.

According to the method of the embodiment of this disclosure, energy consumption may be lowered, thereby reducing energy consumption of the communication system.

### Embodiment of a Second Aspect

The embodiment of this disclosure provides a method for controlling signal transmission, which shall be described from a side of a network device.

FIG. 11 is a schematic diagram of the method for controlling signal transmission in the embodiment of this disclosure. As shown in FIG. 11, the method includes:

1101: a network device transmits information to a first node so that the first node, based on information received from the network device and/or detection of a signal from the network device and/or a terminal equipment, starts or closes a first unit used to transmit a first signal to the network device or the terminal equipment.

In some embodiments, the information is first information, such that the first node starts or closes the first unit based on the information received from the network device.

In some embodiments, the information is configuration information including reference signal (referred to as a first reference signal) of the network device and/or configuration information including reference signal (referred to as a second reference signal) of the terminal equipment, such that the first node starts or closes the first unit based on detection of the first reference signal from the network device and/or detection of the second reference signal from the terminal equipment.

The above embodiments only illustrate the above information. However, this disclosure is not limited thereto, and appropriate variants may be made on the basis of these embodiments. For example, the above embodiments may be executed separately, or one or more of them may be executed in a combined manner.

In some embodiments, the above first information includes one of the following or a combination thereof: RRC configuration information, an MAC CE, and DCI; however, this disclosure is not limited thereto.

In the above embodiment, in one example, the RRC configuration information includes second information indicating starting or closing the first unit, so that the first node starts or closes the first unit via the second information.

In the above embodiment, in another example, in a case where the RRC configuration information does not include the second information indicating starting or closing the first unit, the first node is made to start the first unit. That is, transmission of the RRC configuration information is used to make the first node to start the first unit. In this example, the first unit is in a closed state by default, and when the first node receives the RRC configuration information, it starts the first unit.

In the above embodiment, in a further example, in a case where the RRC configuration information does not include the second information indicating starting or closing the first unit, the first node is made to close the first unit. That is, transmission of the RRC configuration information is used to make the first node to close the first unit. In this example, the first unit is in a started state by default, and when the first node receives the RRC configuration information, it closes the first unit.

In the embodiments of this disclosure, in some embodiments, the network device further transmits third information to the first node, the third information being used to configure a state of the first node or the terminal equipment in receiving the information from the network device.

In some embodiments, the network device uses the above third information to configure the first node not to enter into an idle state autonomously and/or maintain a connected state, so that a state in which the first node receives the information from the network device is to maintain receiving information from the network device.

For example, the network device does not configure dataInactivity Timer for the first node. For example, the network device may change conditions on configuration, that is, the third information transmitted by the network device to the first node (referred to as first configuration information) does not include dataInactivityTimer configuration for the first node. That is, if the first configuration information is transmitted to the first node, the first configuration information does not include dataInactivityTimer; otherwise (for example, the first configuration information is transmitted to the terminal equipment), the first configuration information includes dataInactivity Timer.

For another example, the network device may perform no processing (i.e. there exists no influence on protocols), that is, the first configuration information transmitted by the network device to the first node includes dataInactivityTimer configuration for the first node, but the first node ignores or does not apply the dataInactivityTimer configuration included in the first configuration information transmitted by the network device.

For a further example, the network device may configure for the first node that dataInactivityTimer is an infinite value, that is, the network device transmits the first configuration information to the first node, and the first configuration information includes the dataInactivityTimer configuration for the first node, but the value of dataInactivityTimer is an infinite value.

In some other embodiments, the network device uses the above third information to configure the first node not to deactivate a secondary cell where the first node is located autonomously in a case where the first node is configured with carrier aggregation, so that a state in which the first node receives the information from the network device is to maintain receiving information from the network device.

For example, the network device does not configure sCellDeactivation Timer for the first node. For example, the network device may change conditions on configuration, that is, the third information transmitted by the network device to the first node (referred to as second configuration information) does not include sCellDeactivationTimer configuration for the first node. That is, if the second configuration information is transmitted to the first node, the second configuration information does not include sCellDeactivationTimer; otherwise (for example, the second configuration information is transmitted to the terminal equipment), the second configuration information includes sCellDeactivation Timer.

For another example, the network device may perform no processing (i.e. there exists no influence on protocols), that is, the second configuration information transmitted by the network device to the first node includes sCellDeactivationTimer configuration for the first node, but the first node ignores or does not apply the sCellDeactivationTimer configuration included in the second configuration information transmitted by the network device.

For a further example, the network device may configure for the first node that sCellDeactivationTimer is an infinite value, that is, the network device transmits the second configuration information to the first node, and the second configuration information includes the sCellDeactivation Timer configuration for the first node, but the value of sCellDeactivation Timer is an infinite value.

In some other embodiments, the network device uses the third information to configure the first node not to use a dormant BWP in a case where the first node is configured with a BWP, so that a state in which the first node receives the information from the network device is to maintain receiving information from the network device.

For example, the network device does not configure DormantBWP-Config for the first node. For example, the network device may change conditions on configuration, that is, the third information transmitted by the network device to the first node (referred to as third configuration information) does not include DormantBWP-Config configuration for the first node. That is, if the third configuration information is transmitted to the first node, the third configuration information does not include DormantBWP-Config; otherwise (for example, the third configuration information is transmitted to the terminal equipment), the third configuration information includes DormantBWP-Config.

For another example, the network device may perform no processing (i.e. there exists no influence on protocols), that is, the third configuration information transmitted by the network device to the first node includes DormantBWP-Config configuration for the first node, but the first node ignores or does not apply the DormantBWP-Config configuration included in the third configuration information transmitted by the network device.

In some other embodiments, the network device uses the third information to configure the first node not to support autonomous switching to a default BWP in a case where the first node is configured with a BWP, so that a state in which the first node receives the information from the network device is to maintain receiving information from the network device.

For example, the network device does not configure bwp-InactivityTimer for the first node. For example, the network device may change conditions on configuration, that is, the third information transmitted by the network device to the first node (referred to as fourth configuration information) does not include bwp-InactivityTimer configuration for the first node. That is, if the fourth configuration information is transmitted to the first node, the fourth configuration information does not include bwp-InactivityTimer; otherwise (for example, the fourth configuration information is transmitted to the terminal equipment), the fourth configuration information includes bwp-Inactivity Timer.

For another example, the network device may perform no processing (i.e. there exists no influence on protocols), that is, the fourth configuration information transmitted by the network device to the first node includes bwp-InactivityTimer configuration for the first node, but the first node ignores or does not apply the bwp-InactivityTimer configuration included in the fourth configuration information transmitted by the network device.

For a further example, the network device may configure for the first node that bwp-Inactivity Timer is an infinite value, that is, the network device transmits the fourth configuration information to the first node, and the fourth configuration information includes the bwp-Inactivity Timer configuration for the first node, but the value of bwp-InactivityTimer is an infinite value.

The above embodiments only illustrate that the network device makes the first node via the third information to maintain receiving the information from the network device. However, this disclosure is not limited thereto, and appropriate variants may be made on the basis of these embodiments. For example, the above embodiments may be executed separately, or one or more of them may be executed in a combined manner.

In the embodiments of this disclosure, in some embodiments, the network device configures the first node with DRX.

In some embodiments, the network device configures one DRX for the first node, the one DRX configuration is used for a terminal equipment that may possibly be served by the first node, and the terminal equipment that may possibly be served may be in an idle state/inactive state, or a connected state.

For example, the network device may transmit fifth configuration information to the first node, the fifth configuration information includes a DRX configuration, and the DRX configuration is used for the terminal equipment that may possibly be served by the first node in the idle and/or inactive state and/or the connected state.

In the above embodiment, the DRX configuration includes: a DRX cycle, an on duration value, an inactivity-timer value, and a retransmission-timer value.

In one embodiment, the above DRX configuration includes a first DRX cycle or a second DRX cycle, or a smaller one in the first DRX cycle and the second DRX cycle. The first DRX cycle is a minimum cycle of the terminal equipment in the idle and/or inactive state, and the second DRX cycle is a minimum cycle of the terminal equipment in the connected state. That is, the DRX cycle of the DRX configuration is the minimum cycle of the terminal equipment in the idle and/or inactive state, or the minimum cycle of the terminal equipment in the connected state, or a smaller one in the minimum cycle of the terminal equipment in the idle and/or inactive state and the minimum cycle of the terminal equipment in the connected state.

In one embodiment, the above DRX configuration includes a first on-duration value or a second on-duration value, or a larger one in the first on-duration value and the second on-duration value. The first on-duration value is a maximum on-duration value of the terminal equipment in the idle and/or inactive state, or a maximum on-duration value in a DRX cycle of the terminal equipment in the idle and/or inactive state, and the second on-duration value is a maximum on-duration value of the terminal equipment in the connected state, or a maximum on-duration value in a DRX cycle of the terminal equipment in the connected state. That is, the on-duration value of the DRX configuration is the maximum on-duration value of the terminal equipment in the idle and/or inactive state, or the maximum on-duration value in a DRX cycle of the terminal equipment in the idle and/or inactive state, or the maximum on-duration value of the terminal equipment in the connected state, or the maximum on-duration value in a DRX cycle of the terminal equipment in the connected state.

In one embodiment, the above DRX configuration includes a first inactivity-timer value, and the first inactivity-timer value is a minimum inactivity-timer value of the terminal equipment in the connected state. That is, the inactive-timer value of the DRX configuration is the minimum inactivity-timer value of the terminal equipment in the connected state.

In one embodiment, the above DRX configuration includes a first retransmission-timer value, and the first retransmission-timer value is a maximum retransmission-timer value of the terminal equipment in the connected state. That is, the retransmission-timer value of the DRX configuration is the maximum retransmission-timer value of the terminal equipment in the connected state.

In some other embodiments, the network device may configure at least two DRXes for the first node, namely, a group of DRX parameters, the DRX parameters including a DRX cycle, an on-duration value, an inactivity-timer value, and a retransmission-timer value, etc. The two DRX configurations are used for terminal equipment that may possibly be served by the first node, and the terminal equipment that may possibly be served may be in an idle/inactive state, or may be in a connected state. For example, the network device may transmit sixth configuration information to the first node, the sixth configuration information including at least two DRX configurations. And for the first node, it is able to receive the sixth configuration information.

In one embodiment, the above at least two DRX configurations are used for terminal equipment that may possibly be served by the first node, and each of the terminal equipments that may possibly be served corresponds to a DRX configuration. That is, the network device configures a DRX for each of the terminal equipments that may possibly be served.

In another embodiment, the above at least two DRX configurations are two DRX configurations, one of which is used for terminal equipment in an idle or inactive state that may possibly be served by the first node, and the other is used for terminal equipment in a connected state that may possibly be served by the first node. That is, the network device configures two DRXes for the terminal equipment, one of which is configured for the terminal equipment in the idle or inactive state that may possibly be served, and the other is configured for the terminal equipment in the connected state that may possibly be served.

In a further embodiment, the above at least two DRX configurations are two DRX configurations, one of which has a short DRX cycle, and the other has a long DRX cycle. That is, the network device configures the terminal equipment with two DRXes, one of which has a short DRX cycle, and the other has a long DRX cycle.

In still another embodiment, the above at least two DRX configurations are two DRX configurations, one of which has a large on-duration value, and the other has a small on-duration value. That is, the network device configures the terminal equipment with two DRXes, one of which has a large on-duration value, and the other has a small on-duration value.

The steps or processes related to this disclosure are only described above; however, this disclosure is not limited thereto. The method of the embodiment of this disclosure may also include other steps or processes, and reference may be made to relevant techniques for specific contents of these steps or processes.

The above implementations only illustrate the embodiment of this disclosure. However, this disclosure is not limited thereto, and appropriate variants may be made on the basis of these implementations. For example, the above implementations may be executed separately, or one or more of them may be executed in a combined manner.

According to the method of the embodiment of this disclosure, energy consumption may be lowered, thereby reducing energy consumption of the communication system.

### Embodiment of a Third Aspect

The embodiment of this disclosure provides an apparatus for controlling signal transmission. The apparatus may be, for example, a first node, or one or some components or assemblies configured in the first node. The first node is the above additional node/device/entity, such as the repeater or RIS in the scenario shown in FIG. 1, or the repeater in the scenario shown in FIG. 2 or 3, or the IAB-node shown in FIG. 4, or the TRP in the scenario shown in FIG. 5, or the VMR shown in FIG. 6. In the following description, for sake of convenience, the node/device/entity in the above scenarios is referred to as a first node. However, this disclosure is not limited thereto, and the node/device/entity in the above scenarios may be in other names.

FIG. 12 is a schematic diagram of the apparatus for controlling signal transmission in the embodiment of this disclosure. As a principle of the apparatus for solving problems is identical to that of the method in the embodiment of the first aspect, reference may be made to the implementation of the method in the embodiment of the first aspect for implementation of the apparatus, with identical contents being not going to be repeated herein any further.

As shown in FIG. 12, the apparatus 1200 for controlling signal transmission in the embodiment of this disclosure includes a first unit 1201 and a second unit 1202, wherein,
the first unit 1201 is configured to transmit a first signal to a network device or a terminal equipment, and the second unit 1202 is configured to start or close the first unit based on information received from the network device and/or detection of a signal from the network device or the terminal equipment.

In some embodiments, the first unit 1201 is further configured to receive a second signal from the terminal equipment or network device, process the second signal, and generate the first signal.

In the above embodiment, that the first unit 1201 processes the second signal includes performing one or more of power amplification processing, beamforming processing, and reshaping propagation environment processing on the second signal. According to different implementation scenarios of the first node, the processing performed by the first unit 1201 is also different, which is as described above, and shall not be repeated herein any further.

In some embodiments, that the second unit 1202 starts or closes the first unit based on information received from the network device includes:
starting or closing the first unit 1201 by the second unit 1202 based on one or more of RRC configuration information, an MAC CE and DCI received from the network device.

In the above embodiments, in some implementations, transmission of the RRC configuration information indicates starting the first unit 1201, or indicates closing the first unit 1201. That is, whether the RRC configuration information is transmitted or not is used to indicate starting the first unit 1201 or closing the first unit 1201.

In the above embodiments, in some other implementations, the RRC configuration information includes first information, the first information being used to indicate starting or closing the first unit 1201. That is, starting or closing the first unit 1201 is indicated by the first information.

In some embodiments, the RRC configuration information further includes time-frequency information carrying the first signal.

In some embodiments, the first node is in single connectivity with the network device that transmits the information; or, the first node is in dual connectivity with the network device that transmits the information and a second network device, and the network device that transmits the information is a primary network device that provides services to the first node.

In some embodiments, the MAC CE is used to indicate starting or closing the first unit 1201. For example, in a case where the first node is configured with carrier aggregation or not, the MAC CE may be used to indicate starting or closing the first unit 1201.

In some embodiments, the MAC CE is used to indicate starting or closing the first unit 1201 corresponding to one or more carriers. For example, in a case where the first node is configured with carrier aggregation, the MAC CE may be used to indicate starting or closing the first unit 1201 corresponding to one or more carriers.

In the above embodiment, the MAC CE includes the one or more carriers and information on starting or closing the first unit corresponding to the carriers.

In the above embodiment, the MAC CE is transmitted on a primary carrier or on a first carrier, the first carrier referring to a carrier in a licensed band, or a carrier with no shared spectrum channel operation configured, or a carrier carrying a control channel, or a carrier carrying a common channel, or a carrier serving as a downlink reference.

In some embodiments, the DCI is a common indication for more than one first nodes. For example, the DCI is CRC scrambled via a P-RNTI.

In some implementations, the DCI may use DCI format 1_0, and one bit of the DCI is used to indicate starting or closing the first unit.

In some implementations, the DCI schedules a PDSCH, the PDSCH carrying information containing identifier(s) of one or more first nodes.

In some embodiments, the DCI is a dedicated indication for a first node. For example, the DCI is CRC scrambled via a first RNTI, the DCI uses a first DCI format, and one bit and/or more bits of the DCI is/are used to indicate starting or closing the first unit.

In some implementations, the first DCI format is DCI format 2_6, the first RNTI is a PS-RNTI, and one bit of the DCI is used to indicate starting or closing the first unit. If the DCI further includes SCell dormancy indication information, another bit of the DCI is used to indicate whether the SCell dormancy indication information is applicable to a corresponding first unit.

In some other implementations, the first DCI format is DCI format 2_6, the first RNTI is a PS-RNTI, a first bit of the DCI is used to indicate starting or closing the first unit, and a second bit of the DCI is used to indicate wakeup. When the second bit is set to be a predetermined value, the first bit is valid; otherwise, the first bit is ignored.

In some other implementations, the first DCI format is DCI format 2_6, the first RNTI is a PS-RNTI, and multiple bits of the DCI are used to indicate starting or closing the first unit. When one of the multiple bits is set to be a first predetermined value, it indicates closing a corresponding first unit; and when one of the multiple bits is set to be a second predetermined value, it indicates starting a corresponding first unit.

In the above implementations, in one example, the bit number of the multiple bits of the DCI used to indicate starting or closing the first unit is related to an RF capability of the terminal equipment, and a highest bit in the multiple bits corresponds to a radio frequency with a lowest or highest center frequency point.

In the above implementations, in another example, the bit number of the multiple bits of the DCI used to indicate starting or closing the first unit is the number of first unit on/off cell groups, a first unit on/off cell group is associated with one or more cells, and a highest bit in the multiple bits corresponds to a configured first one of the first unit on/off cell groups.

In some other implementations, the first DCI format is a new DCI format, the first RNTI is a new RNTI, and one or more bits of the DCI is/are used to indicate starting or closing the first unit. When one of the multiple bits is set to be a first predetermined value, it indicates closing a corresponding first unit; and when one of the multiple bits is set to be a second predetermined value, it indicates starting a corresponding first unit.

In the above implementations, in one example, the bit number of the multiple bits of the DCI used to indicate starting or closing the first unit is related to the RF capability of the terminal equipment, and the highest bit in the multiple bits corresponds to the radio frequency with a lowest or highest center frequency point.

In the above implementations, in another example, the bit number of the multiple bits of the DCI used to indicate starting or closing the first unit is the number of first unit on/off cell groups, a first unit on/off cell group is associated with one or more cells, and a highest bit in the multiple bits corresponds to a configured first one of the first unit on/off cell groups.

In some other implementations, the first DCI format is DCI format 1_0 or DCI format 1_1, the first RNTI is a new RNTI, and one or more bits of the DCI are used to indicate starting or closing the first unit. When one of the multiple bits is set to be a first predetermined value, it indicates closing a corresponding first unit; and when one of the multiple bits is set to be a second predetermined value, it indicates starting a corresponding first unit.

In the above implementations, in one example, the bit number of the multiple bits of the DCI used to indicate starting or closing the first unit is related to the RF capability of the terminal equipment, and the highest bit in the multiple bits corresponds to the radio frequency with a lowest or highest center frequency point.

In the above implementations, in another example, the bit number of the multiple bits of the DCI used to indicate starting or closing the first unit is the number of first unit on/off cell groups, a first unit on/off cell group is associated with one or more cells, and a highest bit in the multiple bits corresponds to a configured first one of the first unit on/off cell groups.

In the above implementations, in a further example, if the one bit or one of the multiple bits of the DCI is used to indicate closing the first unit, resource allocation bits of the DCI is reserved; otherwise, the first DCI format indicates time-frequency resources of the scheduled PDSCH.

In some other implementations, the first DCI format is DCI format 1_0 or DCI format 1_1, the first RNTI is a C-RNTI, and one or more bits of the DCI is/are used to indicate starting or closing the first unit. When one of the multiple bits is set to be a first predetermined value, it indicates closing a corresponding first unit; and when one of the multiple bits is set to be a second predetermined value, it indicates starting a corresponding first unit.

In the above implementations, in one example, the bit number of the multiple bits of the DCI used to indicate starting or closing the first unit is related to the RF capability of the terminal equipment, and the highest bit in the multiple bits corresponds to the radio frequency with a lowest or highest center frequency point.

In the above implementations, in another example, the bit number of the multiple bits of the DCI used to indicate starting or closing the first unit is the number of first unit on/off cell groups, a first unit on/off cell groups is associated with one or more cells, and a highest bit in the multiple bits corresponds to a configured first one of the first unit on/off cell groups.

In the embodiment of this disclosure, the second unit 1202 may further perform one or more of the following:
receiving first configuration information from the network device, wherein the first configuration information does not include dataInactivityTimer configuration for the first node, or ignoring or not applying dataInactivityTimer configuration included in the first configuration information;
receiving first configuration information from the network device, the first configuration information including dataInactivityTimer configuration, a value of dataInactivityTimer being configured to be infinite;
not performing data inactivity monitoring;
not indicating expiration of dataInactivityTimer to an upper layer;
not performing a behavior of entering an RRC idle state when expiration of dataInactivityTimer from a lower layer is received;
receiving second configuration information from the network device, wherein, the second configuration information does not include sCellDeactivationTimer configuration for the first node, or ignoring or not applying sCellDeactivationTimer configuration included in the second configuration information;
receiving second configuration information from the network device, the second configuration information including sCellDeactivationTimer configuration, a value of sCellDeactivation Timer being configured to be infinite;
receiving third configuration information from the network device, wherein, the third configuration information does not include DormantBWP-Config for the first node, or ignoring or not applying DormantBWP-Config included in the third configuration information;
not performing bandwidth part (BWP) switching, or maintaining a currently active BWP, or performing BWP switching to a default BWP, in receiving a PDCCH indicating entering into a dormant BWP;
receiving fourth configuration information from the network device, wherein, the fourth configuration information does not include bwp-InactivityTimer for the first node, or ignoring or not applying bwp-InactivityTimer included in the fourth configuration information;
receiving fourth configuration information from the network device, the fourth configuration information including bwp-InactivityTimer, a value of bwp-InactivityTimer being configured to be infinite;
not starting or restarting bwp-InactivityTimer; and
not performing BWP switching, or maintaining a currently activated BWP, when bwp-Inactivity Timer associated with an active downlink bandwidth part (DL BWP) expires.

In some embodiments, the second unit 1202 may further perform one or more of the following:
not performing discontinuous reception (DRX);
receiving fifth configuration information transmitted by the network device, the fifth configuration information including a DRX configuration, the DRX configuration being used for the terminal equipment that may possibly be served by the first node in the idle/inactive state and/or the connected state;
receiving sixth configuration information transmitted by the network device, the sixth configuration information including at least two DRX configurations,
the at least two DRX configurations being used for terminal equipment that may possibly be served by the first node, each of the terminal equipments that may possibly be served corresponding to a DRX configuration;
or, the at least two DRX configurations being two DRX configurations, one of which is used for terminal equipment in an idle or inactive state that may possibly be served by the first node, and the other is used for terminal equipment in a connected state that may possibly be served by the first node;
or, the at least two DRX configurations being two DRX configurations, one of which has a short DRX cycle, and the other has a long DRX cycle;
or, the at least two DRX configurations being two DRX configurations, one of which has a large on-duration value, and the other has a small on-duration value.

In the above embodiment, in some implementations,
the DRX configuration included in the fifth configuration information includes a first DRX cycle or a second DRX cycle, or a smaller one in the first DRX cycle and the second DRX cycle; the first DRX cycle is a minimum cycle of the terminal equipment in the idle and/or inactive state, and the second DRX cycle is a minimum cycle of the terminal equipment in the connected state;
the DRX configuration included in the fifth configuration information includes a first on-duration value or a second on-duration value, or a larger one in the first on-duration value and the second on-duration value; the first on-duration value is a maximum on-duration value of the terminal equipment in the idle and/or inactive state, or a maximum on-duration value in a DRX cycle of the terminal equipment in the idle and/or inactive state, and the second on-duration value is a maximum on-duration value of the terminal equipment in the connected state, or a maximum on-duration value in a DRX cycle of the terminal equipment in the connected state;
the DRX configuration included in the fifth configuration information includes a first inactivity-timer value, and the first inactivity-timer value is a minimum inactivity-timer value of the terminal equipment in the connected state;
the DRX configuration included in the fifth configuration information includes a first retransmission-timer value, and the first retransmission-timer value is a maximum retransmission-timer value of the terminal equipment in the connected state.

In the embodiments of this disclosure, in some embodiments, the second unit 1202 obtains measurement results based on measurement of the signals from the network device or the terminal equipment, and if the measurement results satisfy predetermined conditions, it starts or closes the first unit.

In the above embodiments, the measurement based on the signals from the network device or the terminal equipment includes at least one of the following:
SINR measurement based on the signals from the network device or the terminal equipment,
measurement of RSRP or RSRQ based on the signals from the network device or the terminal equipment, and
measurement of RSSI based on the signals from the network device or the terminal equipment.

In the above embodiments, after obtaining the measurement results, the second unit 1202 may further process the measurement results and compare the processed measurement results with the predetermined conditions; wherein the processing includes hysteresis processing or specific offset processing.

In the above embodiments, that the measurement results satisfy the predetermined conditions refers to that one or more measurement results of one or more measurement quantities in the measurement results satisfy or simultaneously satisfy the predetermined conditions, or, that the measurement results satisfy the predetermined conditions within a certain period of time.

In the embodiment of this disclosure, in some embodiments, that the second unit 1202 closes the first unit includes the second unit performs one of the following behaviors:
closing a power amplifier;
reducing channels;
closing a radio frequency chain (RF chain) used for transmitting and receiving with the terminal equipment;
closing an associated timer;
clearing associated configured downlink assignment and a configured uplink grant type 2;
clearing associated physical uplink shared channel (PUSCH) resources of semi-persistent channel state information (CSI) reporting;
suspending or clearing associated configured uplink grant type 1;
flushing all associated hybrid automatic repeat request (HARQ) buffers;
releasing a physical downlink control channel (PDCCH);
releasing a downlink reference signal;
stopping or relaxing measurement for an uplink reference signal; and
initializing parameter configuration.

In the embodiments of this disclosure, in some embodiments, that the second unit 1202 starts the first unit includes the second unit 1202 performs one of the following behaviors:
starting a power amplifier;
increasing channels;
starting a radio frequency chain used for transmitting and receiving with the terminal equipment;
stopping an associated timer;
initializing and starting a suspended configured uplink grant type 1 according to stored configuration; and
starting measurement for an uplink reference signal.

It should be noted that the components or modules related to this disclosure are only described above. However, this disclosure is not limited thereto, and the apparatus 1200 for controlling signal transmission may further include other components or modules, and reference may be made to related techniques for particulars of these components or modules.

Furthermore, for the sake of simplicity, connection relationships between the components or modules or signal profiles thereof are only illustrated in FIG. 12. However, it should be understood by those skilled in the art that such related techniques as bus connection, etc., may be adopted. And the above components or modules may be implemented by hardware, such as a processor, a memory, a transmitter, and a receiver, etc., which are not limited in the embodiment of this disclosure.

According to the apparatus of the embodiment of this disclosure, energy consumption may be lowered, thereby reducing energy consumption of the communication system.

### Embodiment of a Fourth Aspect

The embodiment of this disclosure provides an apparatus for controlling signal transmission. The apparatus may be, for example, a network device, or one or some components or assemblies configured in the network device.

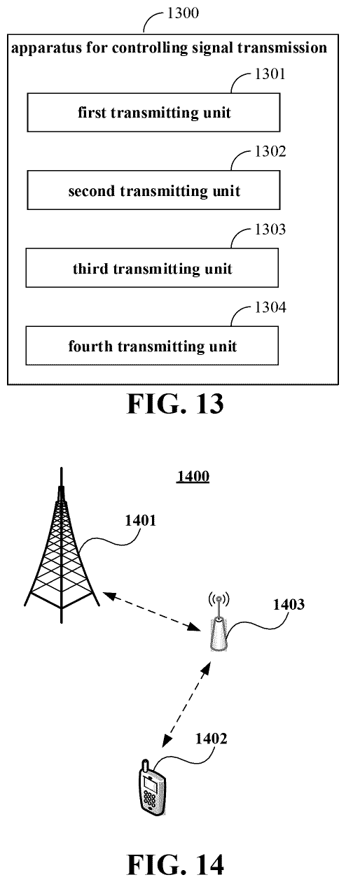

FIG. 13 is a schematic diagram of the apparatus for controlling signal transmission in the embodiment of this disclosure. As a principle of the apparatus for solving problems is identical to that of the method in the embodiment of the second aspect, reference may be made to the implementation of the method in the embodiment of the second aspect for implementation of the apparatus, with identical contents being not going to be repeated herein any further.

As shown in FIG. 13, the apparatus 1300 for controlling signal transmission in the embodiment of this disclosure includes:
a first transmitting unit 1301 configured to transmit information to a first node so that the first node, based on information received from the network device and/or detection of a signal from the network device or a terminal equipment, starts or closes a first unit used to transmit a first signal to the network device or the terminal equipment,
wherein the information is first information, such that the first node starts or closes the first unit based on the information received from the network device; and/or
the information is configuration information including a first reference signal of the network device and/or configuration information including a second reference signal of the terminal equipment, such that the first node starts or closes the first unit based on detection of the first reference signal from the network device and/or detection of the second reference signal from the terminal equipment.

In some embodiments, the first information includes one of the following or a combination thereof: RRC configuration information, an MAC CE, and DCI.

In some implementations, the RRC configuration information includes second information indicating starting or closing the first unit.

In some implementations, in a case where the RRC configuration information does not include the second information indicating starting or closing the first unit, the first node is made to start the first unit.

In some implementations, in a case where the RRC configuration information does not include the second information indicating starting or closing the first unit, the first node is made to close the first unit.

In some embodiments, as shown in FIG. 13, the apparatus 1300 further includes:
a second transmitting unit 1302 configured to transmit third information, the third information being used to configure a state of the first node or the terminal equipment in receiving the information from the network device.

In some implementations, the network device uses the third information to configure the first node not to enter into an idle state autonomously and/or maintain a connected state, so that a state in which the first node receives the information from the network device is to maintain receiving information from the network device.

In some examples, the third information is first configuration information, and in a case where the first configuration information is transmitted to the first node, the first configuration information does not include dataInactivityTimer configuration for the first node; or, the first configuration information includes dataInactivityTimer configuration for the first node; or, the first configuration information includes dataInactivityTimer configuration for the first node, and a value of dataInactivityTimer is an infinite value.

In some implementations, the network device uses the third information to configure the first node not to deactivate a secondary cell where the first node is located autonomously in a case where the first node is configured with carrier aggregation, so that a state in which the first node receives the information from the network device is to maintain receiving information from the network device.

In some examples, the third information is second configuration information, and in a case where the second configuration information is transmitted to the first node, the second configuration information does not include sCellDeactivation Timer configuration for the first node; or, the second configuration information includes sCellDeactivationTimer configuration for the first node; or, the second configuration information includes sCellDeactivationTimer configuration for the first node, but a value of sCellDeactivationTimer is an infinite value.

In some implementations, the network device uses the third information to configure the first node not to use a dormant BWP in a case where the first node is configured with a BWP, so that a state in which the first node receives the information from the network device is to maintain receiving information from the network device.

In some examples, the third information is third configuration information, and in a case where the third configuration information is transmitted to the first node, the third configuration information does not include DormantBWP-Config configuration for the first node; or, the third configuration information includes DormantBWP-Config configuration for the first node.

In some implementations, the network device uses the third information to configure the first node not to support autonomous switching to a default BWP in a case where the first node is configured with a BWP, so that a state in which the first node receives the information from the network device is to maintain receiving information from the network device.

In some examples, the third information is fourth configuration information, and in a case where the fourth configuration information is transmitted to the first node, the fourth configuration information does not include bwp-InactivityTimer configuration for the first node; or, the fourth configuration information includes bwp-InactivityTimer configuration for the first node; or, the fourth configuration information includes bwp-Inactivity Timer configuration for the first node, but a value of bwp-Inactivity Timer is an infinite value.

In some embodiments, as shown in FIG. 13, the apparatus 1300 further includes:
a third transmitting unit 1303 configured to transmit fifth configuration information to the first node, the fifth configuration information including a DRX configuration, the DRX configuration being used for the terminal equipment that may possibly be served by the first node in the idle and/or inactive state and/or the connected state.

In some implementations, the DRX configuration includes a first DRX cycle or a second DRX cycle, or a smaller one in the first DRX cycle and the second DRX cycle. The first DRX cycle is a minimum cycle of the terminal equipment in the idle and/or inactive state, and the second DRX cycle is a minimum cycle of the terminal equipment in the connected state.

In some implementations, the DRX configuration includes a first on-duration value or a second on-duration value, or a larger one in the first on-duration value and the second on-duration value. The first on-duration value is a maximum on-duration value of the terminal equipment in the idle and/or inactive state, or a maximum on-duration value in a DRX cycle of the terminal equipment in the idle and/or inactive state, and the second on-duration value is a maximum on-duration value of the terminal equipment in the connected state, or a maximum on-duration value in a DRX cycle of the terminal equipment in the connected state.

In some implementations, the DRX configuration includes a first inactivity-timer value, and the first inactivity-timer value is a minimum inactivity-timer value of the terminal equipment in the connected state.

In some implementations, the DRX configuration includes a first retransmission-timer value, and the first retransmission-timer value is a maximum retransmission-timer value of the terminal equipment in the connected state.

In some embodiments, as shown in FIG. 13, the apparatus 1300 further includes:
a fourth transmitting unit 1304 configured to transmit sixth configuration information to the first node, the sixth configuration information including at least two DRX configurations.

In some implementations the at least two DRX configurations are used for terminal equipment that may possibly be served by the first node, each of the terminal equipments that may possibly be served corresponding to a DRX configuration.

In some implementations, the at least two DRX configurations are two DRX configurations, one of which is used for terminal equipment in an idle or inactive state that may possibly be served by the first node, and the other is used for terminal equipment in a connected state that may possibly be served by the first node.

In some implementations, the at least two DRX configurations are two DRX configurations, one of which has a short DRX cycle, and the other has a long DRX cycle.

In some implementations, the at least two DRX configurations are two DRX configurations, one of which has a large on-duration value, and the other has a small on-duration value. That is, the network device configures the terminal equipment with two DRXes, one of which has a large on-duration value, and the other has a small on-duration value.

It should be noted that the components or modules related to this disclosure are only described above. However, this disclosure is not limited thereto, and the apparatus 1300 may further include other components or modules, and reference may be made to related techniques for particulars of these components or modules.

Furthermore, for the sake of simplicity, connection relationships between the components or modules or signal profiles thereof are only illustrated in FIG. 13. However, it should be understood by those skilled in the art that such related techniques as bus connection, etc., may be adopted. And the above components or modules may be implemented by hardware, such as a processor, a memory, a transmitter, and a receiver, etc., which are not limited in the embodiment of this disclosure.

According to the apparatus of the embodiment of this disclosure, energy consumption may be lowered, thereby reducing energy consumption of the communication system.

### Embodiment of a Fifth Aspect

The embodiment of this disclosure provides a communication system. FIG. 14 is a schematic diagram of the communication system of the embodiment of this disclosure. The communication system 1400 includes a network device 1401 and a terminal equipment 1402, and furthermore, the communication system includes a first node 1403. For the sake of simplicity, description is given in FIG. 14 by taking one terminal equipment, one network device and one first node only as an example; however, the embodiment of this disclosure is not limited thereto.

In the embodiment of this disclosure, existing traffics or traffics that may be implemented in the future may be performed between the network device 1401 and the terminal equipment 1402. For example, such traffics may include but not limited to enhanced mobile broadband (eMBB), massive machine type communication (mMTC), ultra-reliable and low-latency communication (URLLC), and vehicle to everything (V2X), etc.

Contents related to the terminal equipment 1402 are not limited in this disclosure. Contents related to the first node 1403 are identical to those in the method in the embodiment of the first aspect, and contents related to the network device 1401 are identical to those in the method in the embodiment of the second aspect, which shall not be repeated herein any further.

The embodiment of this disclosure further provides a node device, which may be, for example, the above-described additional node/device/entity, such as the repeater or RIS in the scenario shown in FIG. 1, or the repeater in the scenario shown in FIG. 2 or FIG. 3, or the IAB-node in the scenario shown in FIG. 4, or the TRP in the scenario shown in FIG. 5, or the VMR in the scenario shown in FIG. 6.

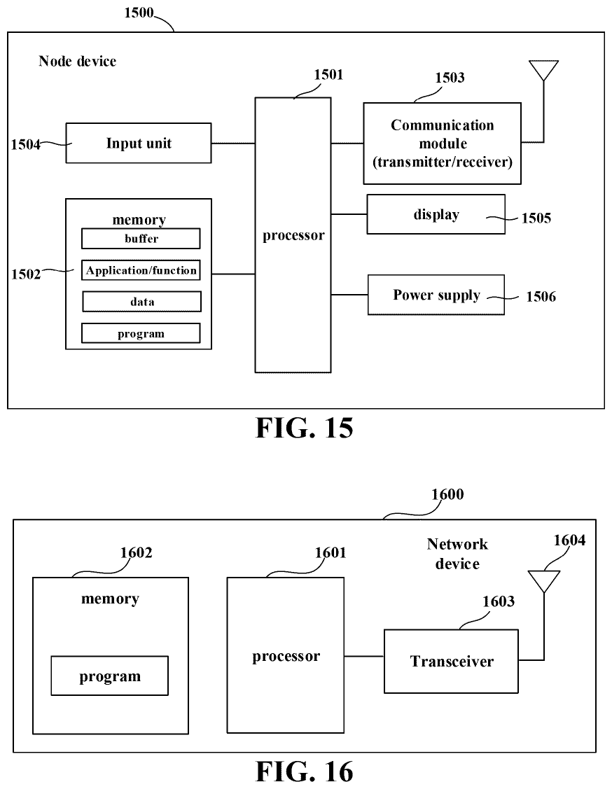

FIG. 15 is a schematic diagram of the node device of the embodiment of this disclosure. As shown in FIG. 15, the node device 1500 may include a processor 1501 and a memory 1502, the memory 1502 storing data and a program and being coupled to the processor 1501. It should be noted that this figure is illustrative only, and other types of structures may also be used, so as to supplement or replace this structure and achieve a telecommunications function or other functions.

For example, the processor 15010 may be configured to execute a program to carry out the method as described in the embodiment of the first aspect.

As shown in FIG. 15, the node device 1500 may further include a communication module 1503, an input unit 1504, a display 1505, and a power supply 1506; wherein functions of the above components are similar to those in the related art, which shall not be described herein any further. It should be noted that the node device 1500 does not necessarily include all the parts shown in FIG. 15, and the above components are not necessary. Furthermore, the node device 1500 may include parts not shown in FIG. 15, and the related art may be referred to.

The embodiment of this disclosure further provides a network device.

FIG. 16 is a schematic diagram of a structure of the network device of the embodiment of this disclosure. As shown in FIG. 16, the network device 1600 may include a central processing unit (CPU) 1601 and a memory 1602, the memory 1602 being coupled to the processor 1601. In this example, the memory 1602 may store various data, and furthermore, it may store a program for information processing, and execute the program under control of the processor 1601, so as to receive various information transmitted by the terminal equipment and transmit various information to the terminal equipment.

For example, the processor 1601 may be configured to execute a program to carry out the method as described in the embodiment of the second aspect.

Furthermore, as shown in FIG. 16, the network device 1600 may include a transceiver 1603, and an antenna 1604, etc., wherein, functions of the above components are similar to those in the related art, and shall not be described herein any further. It should be noted that the network device 1600 does not necessarily include all the parts shown in FIG. 16, and furthermore, the network device 1600 may include parts not shown in FIG. 16, and the related art may be referred to.

An embodiment of this disclosure provides a computer readable program, which, when executed in a node device, will cause a computer to carry out the method as described in the embodiment of the first aspect in the node device.

An embodiment of this disclosure provides a storage medium storing a computer readable program, which will cause a computer to carry out the method as described in the embodiment of the first aspect in the node device.

An embodiment of this disclosure provides a computer readable program, which, when executed in a network device, will cause a computer to carry out the method as described in the embodiment of the second aspect in the network device.

An embodiment of this disclosure provides a storage medium storing a computer readable program, which will cause a computer to carry out the method as described in the embodiment of the second aspect in a network device.

The above apparatuses and methods of this disclosure may be implemented by hardware, or by hardware in combination with software. This disclosure relates to such a computer-readable program that when the program is executed by a logic device, the logic device is enabled to carry out the apparatus or components as described above, or to carry out the methods or steps as described above. This disclosure also relates to a storage medium for storing the above program, such as a hard disk, a floppy disk, a CD, a DVD, and a flash memory, etc.

The methods/apparatuses described with reference to the embodiments of this disclosure may be directly embodied as hardware, software modules executed by a processor, or a combination thereof. For example, one or more functional block diagrams and/or one or more combinations of the functional block diagrams shown in the drawings may either correspond to software modules of procedures of a computer program, or correspond to hardware modules. Such software modules may respectively correspond to the steps shown in the drawings. And the hardware module, for example, may be carried out by firming the soft modules by using a field programmable gate array (FPGA).

The soft modules may be located in an RAM, a flash memory, an ROM, an EPROM, and EEPROM, a register, a hard disc, a floppy disc, a CD-ROM, or any memory medium in other forms known in the art. A memory medium may be coupled to a processor, so that the processor may be able to read information from the memory medium, and write information into the memory medium; or the memory medium may be a component of the processor. The processor and the memory medium may be located in an ASIC. The soft modules may be stored in a memory of a mobile terminal, and may also be stored in a memory card of a pluggable mobile terminal. For example, if equipment (such as a mobile terminal) employs an MEGA-SIM card of a relatively large capacity or a flash memory device of a large capacity, the soft modules may be stored in the MEGA-SIM card or the flash memory device of a large capacity.

One or more functional blocks and/or one or more combinations of the functional blocks in the drawings may be realized as a universal processor, a digital signal processor (DSP), an application-specific integrated circuit (ASIC), a field programmable gate array (FPGA) or other programmable logic devices, discrete gate or transistor logic devices, discrete hardware component or any appropriate combinations thereof carrying out the functions described in this application. And the one or more functional block diagrams and/or one or more combinations of the functional block diagrams in the drawings may also be realized as a combination of computing equipment, such as a combination of a DSP and a microprocessor, multiple processors, one or more microprocessors in communication combination with a DSP, or any other such configuration.

This disclosure is described above with reference to particular embodiments. However, it should be understood by those skilled in the art that such a description is illustrative only, and not intended to limit the protection scope of the present disclosure. Various variants and modifications may be made by those skilled in the art according to the spirits and principle of the present disclosure, and such variants and modifications fall within the scope of the present disclosure.

As to implementations containing the above embodiments, following supplements are further disclosed.
1. A method for controlling signal transmission, wherein the method includes:
starting or closing a first unit used to transmit a first signal to a network device or a terminal equipment by a first node based on information received from the network device and/or detection of a signal from the network device or the terminal equipment.
2. The method according to supplement 1, wherein the first unit is further used to receive a second signal from terminal equipment or network device, and generate the first signal after processing the second signal.
3. The method according to supplement 2, wherein the processing the second signal includes performing one or more of power amplification performing, beamforming performing and reshaping propagation environment performing on the second signal.
4. The method according to supplement 1, wherein the starting or closing the first unit based on information received from the network device includes:
starting or closing the first unit based on one or more of RRC configuration information, an MAC CE and DCI received from the network device.
5. The method according to supplement 4, wherein transmission of the RRC configuration information indicates starting the first unit or indicates closing the first unit.
6. The method according to supplement 4 or 5, wherein the RRC configuration information includes first information, the first information being used to indicate starting or closing the first unit.
7. The method according to supplement 5 or 6, wherein the RRC configuration information further includes time-frequency information carrying the first signal.
8. The method according to supplement 5 or 6, wherein single connectivity exists between the first node and the network device transmitting the RRC configuration information; or, dual connectivity exists between the first node and the network device transmitting the RRC configuration information and a second network device, and the network device transmitting the RRC configuration information is a primary network device that provides services to the first node.
9. The method according to supplement 4, wherein the MAC CE is used to indicate starting or closing the first unit.
10. The method according to supplement 4, wherein the MAC CE is used to indicate starting or closing a first unit corresponding to one or more carriers.
11. The method according to supplement 10, wherein the MAC CE includes the one or more carriers and information on starting or closing the first unit corresponding to the carriers.
12. The method according to supplement 10, wherein the MAC CE is transmitted on a primary carrier or on a first carrier, the first carrier being a carrier in a licensed band, or a carrier with no shared spectrum channel operation configured, or a carrier carrying a control channel, or a carrier carrying a common channel, or a carrier serving as a downlink reference.
13. The method according to supplement 4, wherein the DCI is a common indication for more than one first nodes.
14. The method according to supplement 13, wherein that the DCI is a common indication for more than one first nodes includes:
the DCI being CRC scrambled via a P-RNTI.
15. The method according to supplement 14, wherein the DCI uses DCI format 1_0, and one bit of the DCI is used to indicate starting or closing the first unit.
16. The method according to supplement 14 or 15, wherein the DCI schedules a PDSCH, the PDSCH carrying information containing identifier(s) of one or more first nodes.
17. The method according to supplement 4, wherein the DCI is a dedicated indication for one first node.
18. The method according to supplement 17, wherein that the DCI is a dedicated indication for one first node includes:
the DCI being CRC scrambled via a first RNTI, using a first DCI format, and indicating starting or closing the first unit by using one and/or more bits.
19. The method according to supplement 18, wherein the first DCI format is DCI format 2_6, the first RNTI is a PS-RNTI, one bit of the DCI is used to indicate starting or closing the first unit, and if the DCI further includes SCell dormancy indication information, another bit of the DCI is used to indicate whether the SCell dormancy indication information is applicable to a corresponding first unit.
20. The method according to supplement 18, wherein the first DCI format is DCI format 2_6, the first RNTI is a PS-RNTI, a first bit of the DCI is used to indicate starting or closing the first unit, a second bit of the DCI is used to indicate wakeup, and when the second bit is set to be a predetermined value, the first bit is valid; otherwise, the first bit is ignored.
21. The method according to supplement 18, wherein the first DCI format is DCI format 2_6, the first RNTI is a PS-RNTI, multiple bits of the DCI are used to indicate starting or closing the first unit, and when one of the multiple bits is set to be a first predetermined value, it indicates closing a corresponding first unit; and when one of the multiple bits is set to be a second predetermined value, it indicates starting a corresponding first unit.
22. The method according to supplement 21, wherein the bit number of the multiple bits of the DCI used to indicate starting or closing the first unit is related to an RF capability of the terminal equipment, and a highest bit in the multiple bits corresponds to a radio frequency with a lowest or highest center frequency point.
23. The method according to supplement 21, wherein the bit number of the multiple bits of the DCI used to indicate starting or closing the first unit is the number of first unit on/off cell groups, one of the first unit on/off cell groups is associated with one or more cells, and a highest bit in the multiple bits corresponds to a configured first one of the first unit on/off cell groups.
24. The method according to supplement 18, wherein the first DCI format is a new DCI format, the first RNTI is a new RNTI, and one or more bits of the DCI is/are used to indicate starting or closing the first unit; when one of the multiple bits is set to be a first predetermined value, it indicates closing a corresponding first unit, and when one of the multiple bits is set to be a second predetermined value, it indicates starting a corresponding first unit.
25. The method according to supplement 24, wherein the bit number of the multiple bits of the DCI used to indicate starting or closing the first unit is related to the RF capability of the terminal equipment, and the highest bit in the multiple bits may correspond to the radio frequency with a lowest or highest center frequency point.
26. The method according to supplement 24, wherein the bit number of the multiple bits of the DCI used to indicate starting or closing the first unit is the number of first unit on/off cell groups, one of the first unit on/off cell groups is associated with one or more cells, and a highest bit in the multiple bits corresponds to a configured first one of the first unit on/off cell groups.
27. The method according to supplement 18, wherein the first DCI format is DCI format 1_0 or DCI format 1_1, the first RNTI is a new RNTI, and one or more bits of the DCI are used to indicate starting or closing the first unit; when one of the multiple bits is set to be a first predetermined value, it indicates closing a corresponding first unit, and when one of the multiple bits is set to be a second predetermined value, it indicates starting a corresponding first unit.
28. The method according to supplement 27, wherein the bit number of the multiple bits of the DCI used to indicate starting or closing the first unit is related to the RF capability of the terminal equipment, and the highest bit in the multiple bits corresponds to the radio frequency with a lowest or highest center frequency point
29. The method according to supplement 27, wherein the bit number of the multiple bits of the DCI used to indicate starting or closing the first unit is the number of first unit on/off cell groups, one of the first unit on/off cell groups is associated with one or more cells, and the highest bit in the multiple bits corresponds to a configured first one of the first unit on/off cell groups.
30. The method according to supplement 27, wherein if the one bit or one of the multiple bits of the DCI is/are used to indicate closing the first unit, resource allocation bits of the DCI are reserved; otherwise, the first DCI format indicates time-frequency resources of the scheduled PDSCH.
31. The method according to supplement 18, wherein the first DCI format is DCI format 1_0 or DCI format 1_1, the first RNTI is a C-RNTI, one or more bits of the DCI is/are used to indicate starting or closing the first unit, and when one of the multiple bits is set to be a first predetermined value, it indicates closing a corresponding first unit; and when one of the multiple bits is set to be a second predetermined value, it indicates starting a corresponding first unit.
32. The method according to supplement 31, wherein the bit number of the multiple bits of the DCI used to indicate starting or closing the first unit is related to the RF capability of the terminal equipment, and the highest bit in the multiple bits corresponds to the radio frequency with a lowest or highest center frequency point.
33. The method according to supplement 31, wherein the bit number of the multiple bits of the DCI used to indicate starting or closing the first unit is the number of first unit on/off cell groups, one of the first unit on/off cell groups is associated with one or more cells, and the highest bit in the multiple bits corresponds to a configured first one of the first unit on/off cell groups.
34. The method according to any one of supplements 1-33, wherein the method further includes one of the following:
receiving first configuration information from the network device by the first node, the first configuration information not including dataInactivityTimer configuration for the first node, or, the first node ignoring or not applying the dataInactivityTimer configuration included in the first configuration information;
receiving first configuration information from the network device by the first node, the first configuration information including dataInactivityTimer configuration, and a value of dataInactivityTimer being set to be infinite;
not performing data inactivity monitoring by the first node;
not indicating expiration of dataInactivityTimer by the first node to an upper layer;
not performing a behavior of entering into an RRC idle (RRC_IDLE) state by the first node upon receiving expiration of dataInactivityTimer from a lower layer;
receiving second configuration information from the network device by the first node, the second configuration information not including sCellDeactivationTimer configuration for the first node, or, the first node ignoring or not applying the sCellDeactivation Timer configuration included in the second configuration information;
receiving second configuration information from the network device by the first node, the second configuration information including the sCellDeactivation Timer configuration, and a value of sCellDeactivationTimer being set to be infinite;
receiving third configuration information from the network device by the first node, the third configuration information not including DormantBWP-Config for the first node, or, the first node ignoring or not applying DormantBWP-Config included in the third configuration information;
not performing BWP switching, or maintaining a current active BWP, or performing switching a BWP to a default BWP, by the first node upon receiving a PDCCH indicating entering into a dormant BWP;
receiving fourth configuration information from the network device by the first node, the fourth configuration information not including bwp-Inactivity Timer for the first node, or, the first node ignoring or not applying bwp-InactivityTimer included in the fourth configuration information;
receiving fourth configuration information from the network device by the first node, the fourth configuration information including bwp-InactivityTimer, and a value of bwp-Inactivity Timer being set to be infinite;
not starting or restarting bwp-Inactivity Timer by the first node; and
not performing BWP switching or maintaining the current active BWP by the first node when bwp-Inactivity Timer associated with an active DL BWP expires.
35. The method according to any one of supplements 1-34, wherein the method further includes one of the following:
not performing discontinuous reception (DRX) by the first node;
receiving, by the first node, fifth configuration information transmitted by the network device, the fifth configuration information including a DRX configuration, the DRX configuration being used for terminal equipment in the idle and/or inactive state and/or the connected state that is possibly served by the first node;
receiving, by the first node, sixth configuration information transmitted by the network device, the sixth configuration information including at least two DRX configurations,
the at least two DRX configurations being used for terminal equipment that is possibly served by the first node, and each of the terminal equipments that are possibly served corresponding to a DRX configuration;
or, the at least two DRX configurations being two DRX configurations, one of which being used for terminal equipment in an idle or inactive state that is possibly served by the first node, and the other being used for terminal equipment in a connected state that are possibly served by the first node;
or, the at least two DRX configurations being two DRX configurations, one of which having a short DRX cycle, and the other having a long DRX cycle;
or, the at least two DRX configurations being two DRX configurations, one of which having a large on-duration value, and the other having a small on-duration value.
36. The method according to supplement 35, wherein,
the DRX configuration included in the fifth configuration information includes a first DRX cycle or a second DRX cycle, or a smaller one in the first DRX cycle and the second DRX cycle, the first DRX cycle being a minimum cycle of the terminal equipment in the idle and/or inactive state, and the second DRX cycle being a minimum cycle of the terminal equipment in the connected state;
the DRX configuration included in the fifth configuration information includes a first on-duration value or a second on-duration value, or a larger one in the first on-duration value and the second on-duration value, the first on-duration value being a maximum on-duration value of the terminal equipment in the idle and/or inactive state, or a maximum on-duration value in a DRX cycle of the terminal equipment in the idle and/or inactive state, and the second on-duration value being a maximum on-duration value of the terminal equipment in the connected state, or a maximum on-duration value in a DRX cycle of the terminal equipment in the connected state;
the DRX configuration included in the fifth configuration information includes a first inactivity-timer value, the first inactivity-timer value being a minimum inactivity-timer value of the terminal equipment in the connected state;
and the DRX configuration included in the fifth configuration information includes a first retransmission-timer value, the first retransmission-timer value being a maximum retransmission-timer value of the terminal equipment in the connected state.
37. The method according to supplement 1, wherein the starting or closing a first unit based on detection of a signal from the network device or the terminal equipment includes:
obtaining measurement results based on measurement of the signals from the network device or the terminal equipment, and if the measurement results satisfy a predetermined condition, starting or closing the first unit.
38. The method according to supplement 37, wherein,
the measurement based on the signals from the network device or the terminal equipment includes at least one of the following:
SINR measurement based on the signals from the network device or the terminal equipment,
measurement of RSRP or RSRQ based on the signals from the network device or the terminal equipment, and
measurement of RSSI based on the signals from the network device or the terminal equipment.
39. The method according to supplement 37, wherein after obtaining the measurement results, the method further includes:
processing the measurement results, and comparing the processed measurement results with the predetermined condition,
wherein the processing includes hysteresis processing or specific offset processing.
40. The method according to supplement 37, wherein,
that the measurement results satisfy the predetermined condition refers to that one or more measurement results of one or more measurement quantities in the measurement results satisfy or simultaneously satisfy the predetermined condition, or, that the measurement results satisfy the predetermined condition within a certain period of time.
41. The method according to supplement 1, wherein the closing the first unit by the first node includes performing one of the following behaviors by the first node:
closing a power amplifier;
reducing channels;
closing a radio frequency chain (RF chain) used for transmitting and receiving with the terminal equipment;
closing an associated timer;
clearing associated configured downlink assignment and a configured uplink grant type 2;
clearing associated physical uplink shared channel (PUSCH) resources of semi-persistent channel state information (CSI) reporting;
suspending or clearing associated configured uplink grant type 1;
flushing all associated hybrid automatic repeat request (HARQ) buffers;
releasing a physical downlink control channel (PDCCH);
releasing a downlink reference signal;
stopping or relaxing measurement for an uplink reference signal; and
initializing parameter configuration.
42. The method according to supplement 1, wherein the starting the first unit by the first node includes performing one of the following behaviors by the first node:
starting a power amplifier;
increasing channels;
starting a radio frequency chain used for transmitting and receiving with the terminal equipment;
stopping an associated timer;
initializing and starting a suspended configured uplink grant type 1 according to stored configuration; and
starting measurement for an uplink reference signal.
43. The method according to any one of supplements 1-42, wherein the first node is one of the following nodes or devices or entities:
a repeater;
an RIS;
an IAB-node;
a VMR; and
a TRP.
44. A method for controlling signal transmission, wherein the method includes:
transmitting information by a network device to a first node so that the first node, based on information received from the network device and/or detection of a signal from the network device or a terminal equipment, starts or closes a first unit used to transmit a first signal to the network device or the terminal equipment,
wherein the information is first information, such that the first node starts or closes the first unit based on the information received from the network device; and/or
the information is configuration information including a first reference signal of the network device and/or configuration information including a second reference signal of the terminal equipment, such that the first node starts or closes the first unit based on detection of the first reference signal from the network device and/or detection of the second reference signal from the terminal equipment.
44a. The method according to supplement 44, wherein the first information includes one of the following or a combination thereof: RRC configuration information, an MAC CE, and DCI
44aa. The method according to supplement 44a, wherein the RRC configuration information includes second information indicating starting or closing the first unit.
44ab. The method according to supplement 44a, wherein in a case where the RRC configuration information does not include the second information indicating starting or closing the first unit, the first node is made to start the first unit.
44ac. The method according to supplement 44a, wherein in a case where the RRC configuration information does not include the second information indicating starting or closing the first unit, the first node is made to close the first unit.
44b. The method according to supplement 44, wherein the method further includes:
transmitting third information by the network device, the third information being used to configure a state of the first node or the terminal equipment in receiving the information from the network device.
45. The method according to supplement 44b, wherein the network device uses the third information to configure the first node not to enter into an idle state autonomously and/or maintain a connected state, so that a state in which the first node receives the information from the network device is to maintain receiving information from the network device.
46. The method according to supplement 45, wherein the third information is first configuration information, and in a case where the first configuration information is transmitted to the first node, the first configuration information does not include dataInactivity Timer configuration for the first node; or, the first configuration information includes dataInactivity Timer configuration for the first node; or, the first configuration information includes dataInactivity Timer configuration for the first node, and a value of dataInactivityTimer is an infinite value.
47. The method according to supplement 44b, wherein the network device uses the third information to configure the first node not to deactivate a secondary cell where the first node is located autonomously in a case where the first node is configured with carrier aggregation, so that a state in which the first node receives the information from the network device is to maintain receiving information from the network device.
48. The method according to supplement 47, wherein the third information is second configuration information, and in a case where the second configuration information is transmitted to the first node, the second configuration information does not include sCellDeactivation Timer configuration for the first node; or, the second configuration information includes sCellDeactivation Timer configuration for the first node; or, the second configuration information includes sCellDeactivationTimer configuration for the first node, but a value of sCellDeactivation Timer is an infinite value.
49. The method according to supplement 44b, wherein the network device uses the third information to configure the first node not to use a dormant BWP in a case where the first node is configured with a BWP, so that a state in which the first node receives the information from the network device is to maintain receiving information from the network device.
50. The method according to supplement 49, wherein the third information is third configuration information, and in a case where the third configuration information is transmitted to the first node, the third configuration information does not include DormantBWP-Config configuration for the first node; or, the third configuration information includes DormantBWP-Config configuration for the first node.
51. The method according to supplement 44b, wherein the network device uses the third information to configure the first node not to support autonomous switching to a default BWP in a case where the first node is configured with a BWP, so that a state in which the first node receives the information from the network device is to maintain receiving information from the network device.
52. The method according to supplement 51, wherein the third information is fourth configuration information, and in a case where the fourth configuration information is transmitted to the first node, the fourth configuration information does not include bwp-Inactivity Timer configuration for the first node; or, the fourth configuration information includes bwp-Inactivity Timer configuration for the first node; or, the fourth configuration information includes bwp-Inactivity Timer configuration for the first node, but a value of bwp-Inactivity Timer is an infinite value.
53. The method according to supplement 44, wherein the method further includes:
transmitting fifth configuration information by the network device to the first node, the fifth configuration information including a DRX configuration, the DRX configuration being used for terminal equipment in the idle/inactive state and/or the connected state that is possibly served by the first node.
54. The method according to supplement 53, wherein,
the DRX configuration includes a first DRX cycle or a second DRX cycle, or a smaller one in the first DRX cycle and the second DRX cycle, the first DRX cycle being a minimum cycle of the terminal equipment in the idle and/or inactive state, and the second DRX cycle being a minimum cycle of the terminal equipment in the connected state.
55. The method according to supplement 53, wherein,
the DRX configuration includes a first on-duration value or a second on-duration value, or a larger one in the first on-duration value and the second on-duration value, the first on-duration value being a maximum on-duration value of the terminal equipment in the idle and/or inactive state, or a maximum on-duration value in a DRX cycle of the terminal equipment in the idle and/or inactive state, and the second on-duration value being a maximum on-duration value of the terminal equipment in the connected state, or a maximum on-duration value in a DRX cycle of the terminal equipment in the connected state.
56. The method according to supplement 53, wherein,
the DRX configuration includes a first inactivity-timer value, the first inactivity-timer value being a minimum inactivity-timer value of the terminal equipment in the connected state.
57. The method according to supplement 53, wherein,
the DRX configuration includes a first retransmission-timer value, the first retransmission-timer value being a maximum retransmission-timer value of the terminal equipment in the connected state.
58. The method according to supplement 44, wherein the method further includes:
transmitting sixth configuration information by the network device to the first node, the sixth configuration information including at least two DRX configurations.
59. The method according to supplement 58, wherein,
the at least two DRX configurations are used for terminal equipment that is possibly served by the first node, each of the terminal equipments that are possibly served corresponding to a DRX configuration.
60. The method according to supplement 58, wherein,
the at least two DRX configurations are two DRX configurations, one of which being used for terminal equipment in an idle or inactive state that is possibly served by the first node, and the other being used for terminal equipment in a connected state that are possibly served by the first node.
61. The method according to supplement 58, wherein,
the at least two DRX configurations are two DRX configurations, one of which having a short DRX cycle, and the other having a long DRX cycle.
62. The method according to supplement 58, wherein,
the at least two DRX configurations are two DRX configurations, one of which having a large on-duration value, and the other having a small on-duration value, that is, the network device configures the terminal equipment with two DRXes, one of which having a large on-duration value, and the other having a small on-duration value.
63. A node device, including a memory and a processor, the memory storing a computer program, and the processor being configured to execute the computer program to carry out the method as described in any one of supplements 1-43.
64. A network device, including a memory and a processor, the memory storing a computer program, and the processor being configured to execute the computer program to carry out the method as described in any one of supplements 44-62.
65. A communication system, including a terminal equipment, a first node and a network device, wherein,
the network device is configured to transmit information to the first node so that the first node, based on information received from the network device and/or detection of a signal from the network device and/or the terminal equipment, starts or closes a first unit used to transmit a first signal to the network device or the terminal equipment;
and the first node is configured to, based on information received from the network device and/or detection of a signal from the network device or the terminal equipment, start or close the first unit used to transmit a first signal to the network device or the terminal equipment.

1. An apparatus for controlling signal transmission, configured in a first node, wherein the apparatus comprises:
a first unit configured to forward a first signal to a network device or a terminal equipment; and
a second unit configured to control the first unit to forward or cease forwarding the first signal based on information received from the network device and/or detection of a signal from the network device or the terminal equipment.

2. The apparatus according to claim 1, wherein that the second unit controls the first unit to forward or cease forwarding the first signal based on information received from the network device comprises:
controlling the first unit to forward or cease forwarding the first signal based on one or more of radio resource control (RRC) configuration information, a media access control control element (MAC CE) and downlink control information (DCI) received from the network device.

3. The apparatus according to claim 2, wherein transmission of the RRC configuration information indicates staring the first unit, or indicates closing the first unit.

4. The apparatus according to claim 2, wherein the MAC CE is used to indicate controlling the first unit.

5. The apparatus according to claim 2, wherein the MAC CE is used to indicate controlling the first unit to which one or more carriers correspond, and the MAC CE includes information on the one or more carriers and controlling the first unit to which the one or more carriers correspond.

6. The apparatus according to claim 2, wherein the DCI is a common indication for more than one first nodes.

7. The apparatus according to claim 6, wherein that the DCI is a common indication for more than one first nodes comprises:
that the DCI performs CRC scrambling via a P-RNTI.

8. The apparatus according to claim 7, wherein the DCI uses a DCI format 1_0, and one bit of the DCI is used to indicate controlling the first unit.

9. The apparatus according to claim 7, wherein the DCI schedules a physical downlink shared channel (PDSCH), the PDSCH carrying information containing identifiers of one or more first nodes.

10. The apparatus according to claim 2, wherein the DCI is a dedicated indication for one first node.

11. The apparatus according to claim 10, wherein that the DCI is a dedicated indication for one first node comprises:
that the DCI performs cyclic redundancy check (CRC) scrambling via a first radio network temporary identifier (RNTI), and the DCI uses a first DCI format, one bit and/or multiple bits of the DCI being used to indicate controlling the first unit.

12. The apparatus according to claim 11, wherein the first DCI format is DCI format 2_6, the first RNTI is a PS-RNTI, one bit of the DCI is used to indicate controlling the first unit, and if the DCI further includes secondary cell (SCell) dormancy indication information, another bit of the DCI is used to indicate whether the SCell dormancy indication information is applicable to a corresponding first unit.

13. The apparatus according to claim 11, wherein the first DCI format is DCI format 2_6, the first RNTI is a PS-RNTI, a first bit of the DCI is used to indicate controlling the first unit, a second bit of the DCI is used to indicate wakeup, and when the second bit is set to be of a predetermined value, the first bit is valid, otherwise, the first bit is ignored.

14. The apparatus according to claim 1, wherein the second unit is further configured to perform one of the following:
receiving first configuration information from the network device, wherein, the first configuration information does not include dataInactivityTimer configuration for the first node, or the second unit ignores or does not apply dataInactivityTimer configuration included in the first configuration information;
receiving configuration information from the network device, the first configuration information including dataInactivityTimer configuration, a value of dataInactivityTimer being configured to be infinite;
not performing data inactivity monitoring;
not indicating expiration of dataInactivityTimer to an upper layer;
not performing a behavior of entering an RRC idle state when expiration of dataInactivityTimer from a lower layer is received;
receiving second configuration information from the network device, wherein, the second configuration information does not include sCellDeactivation Timer configuration for the first node, or the second unit ignores or does not apply sCellDeactivationTimer configuration included in the second configuration information;
receiving second configuration information from the network device, the second configuration information including sCellDeactivationTimer configuration, a value of sCellDeactivationTimer being configured to be infinite;
receiving third configuration information from the network device, wherein, the third configuration information does not include DormantBWP-Config for the first node, or the second unit ignores or does not apply DormantBWP-Config included in the third configuration information;
not performing bandwidth part (BWP) switch, or maintaining a currently active BWP, or performing BWP switch to a default BWP, in receiving a PDCCH indicating entering into a dormant BWP;
receiving fourth configuration information from the network device, wherein, the fourth configuration information does not include bwp-InactivityTimer for the first node, or the second unit ignores or does not apply bwp-InactivityTimer included in the fourth configuration information;
receiving fourth configuration information from the network device, the fourth configuration information including bwp-InactivityTimer, a value of bwp-InactivityTimer being configured to be infinite;
not starting or restarting bwp-Inactivity Timer; and
not performing BWP switch, or maintaining a currently activated BWP, when bwp-Inactivity Timer with which an active downlink bandwidth part (DL BWP) is associated expires.

15. The apparatus according to claim 1, wherein that second unit controls the first unit to forward or cease forwarding the first signal based on detection of a signal from the network device or the terminal equipment comprises:
obtaining a measurement result based on measurement of a signal from the network device or the terminal equipment, and controlling the first unit to forward or cease forwarding the first signal if the measurement result satisfies a predetermined condition.

16. The apparatus according to claim 15, wherein,
that the measurement result meeting a predetermined condition refer to that one or more measurement results of one or more measurement quantities in the measurement result meet or simultaneously meet the predetermined condition, or that the measurement result meet the predetermined condition within a certain period of time.

17. The apparatus according to claim 1, wherein,
that the second unit closes the first unit comprises that the second unit performs at least one of the following behaviors:
closing a power amplifier;
reducing channels;
closing a radio frequency chain used for transmitting and receiving with the terminal equipment;
closing an associated timer;
clearing associated configured downlink assignment and a configured uplink grant type 2;
clearing associated physical uplink shared channel (PUSCH) resources reported by semi-persistent channel state information (CSI);
suspending or clearing associated configured uplink grant type 1;
flushing all associated hybrid automatic repeat request (HARQ) buffers;
releasing a physical downlink control channel (PDCCH);
releasing a downlink reference signal;
stopping or relaxing measurement for an uplink reference signal; and
initializing parameter configuration;
that the second unit controls the first unit to forward the first signal comprises that the second unit performs at least one of the following behaviors:
starting a power amplifier;
increasing paths;
starting a radio frequency chain used for transmitting and receiving with the terminal equipment;
stopping an associated timer;
initializing according to stored configuration and starting a suspended configured uplink grant type 1; and
starting measurement for an uplink reference signal.

18. The apparatus according to claim 1, wherein the first node is one of the following nodes or devices or entities:
a repeater;
a reconfigurable intelligent surfaces (RIS);
an integrated access and backhaul (IAB) node;
a vehicle-mounted relay (VMR); and
a transmission reception point (TRP).

19. An apparatus for controlling signal transmission, configured in a network device, wherein the apparatus comprises:
a transmitter configured to transmit information to a first node so that the first node, based on information received from the network device and/or detection of a signal from the network device or a terminal equipment, controls a first unit used to forward or cease forwarding a first signal to the network device or the terminal equipment,
wherein the information is first information, such that the first node controls the first unit to forward or cease forwarding the first signal based on the information received from the network device; and/or
the information is configuration information including a first reference signal of the network device and/or configuration information including a second reference signal of the terminal equipment, such that the first node controls the first unit to forward or cease forwarding the first signal based on detection of the first reference signal from the network device and/or detection of the second reference signal from the terminal equipment.

20. A communication system, comprising a terminal equipment, a first node and a network device, wherein,
the network device is configured to transmit information to the first node so that the first node, based on information received from the network device and/or detection of a signal from the network device and/or the terminal equipment, controls a first unit used to forward or cease forwarding a first signal to the network device or the terminal equipment;
and the first node is configured to, based on information received from the network device and/or detection of a signal from the network device or the terminal equipment, control the first unit used to forward or cease forwarding a first signal to the network device or the terminal equipment.
